(19) United States
(12) Patent Application Publication
(10) Pub. No.: US 2024/0078163 A1
(43) Pub. Date: Mar. 7, 2024

(54) SYSTEMS AND METHODS FOR VISUALIZING MACHINE INTELLIGENCE

(71) Applicant: DataRobot, Inc., Boston, MA (US)

(72) Inventors: Jeremy Achin, Boston, MA (US); Michael Schmidt, Washington, DC (US); Dmitry Zahanych, Kyiv (UA); Alexander Jason Conway, Boston, MA (US); Benjamin Taylor, Lehi, UT (US); Michael William Gilday, Peabody, MA (US); Uros Perisic, Boston, MA (US); Andrii Chulovskyi, Lviv (UA); Romain Briot, Denver, CO (US); Sully Matthew Sullenberger, Olympia, WA (US)

(73) Assignee: DataRobot, Inc., Boston, MA (US)

(21) Appl. No.: 18/506,415

(22) Filed: Nov. 10, 2023

Related U.S. Application Data
(63) Continuation of application No. PCT/US2022/028569, filed on May 10, 2022.
(60) Provisional application No. 63/187,163, filed on May 11, 2021.

(51) Int. Cl. G06F 11/30; G06F 8/60; G06F 11/32

(52) U.S. Cl. CPC G06F 11/3089; G06F 8/60; G06F 11/323

(57) ABSTRACT

A system to deploy virtual sensors to a machine learning project and translate data of the machine learning project is provided. The system can deploy, for a machine learning project, a plurality of virtual sensors at a first location of a plurality of locations to detect metadata of a data source of the machine learning project, at a second location of the plurality of locations to detect deployment information of a model trained for the machine learning project, and at a third location of the plurality of locations to detect learning session information for creation of the model. The system can collect, via the plurality of virtual sensors, data for the machine learning project. The system can translate, for render on a computing system, the data collected via the plurality of virtual sensors into a plurality of graphics.

### CROSS-REFERENCE TO RELATED PATENT APPLICATION

This application claims the benefit of priority under 35 U.S.C. § 120 as a continuation of International Patent Application No. PCT/US2022/028569, filed May 10, 2022, and designating the United States, which claims the benefit of, and priority under 35 U.S.C. § 119 to, U.S. Provisional Patent Application No. 63/187,163, filed May 11, 2021, each of which is hereby incorporated by reference herein in its entirety.

### TECHNICAL FIELD

The present implementations relate generally to machine learning and graphic user interfaces.

### BACKGROUND

A machine learning system can train models based on training data sets. The machine learning system can implement training techniques that determine values for various parameters or weights of the models. The models can execute on inference data sets to make model decisions, predictions, other inferences based on the various values for the parameters or weights. However, the process of designing and deploying a model using machine learning can be complex and difficult for a user to understand or visualize, which can result in errors or inaccuracies in the as-built model.

### SUMMARY

Systems and methods of the technical solution can visualize machine intelligence. A user may have difficulty in comprehending a machine learning project due to the expansive and complex nature of the machine learning project. Furthermore, a system that creates visualizations of the machine learning project may not include an efficient method for tracking the state of the machine learning project. To solve these and other technical problems, the system described herein can generate a graphic representation of the machine learning project. The system can generate a graphic representation in a visual language, e.g., in accordance with a defined set of rules based on data streamed from virtual sensors. The visual language can allow for a user to view the graphic representation of the machine learning project and readily understand the current configuration of the machine learning project without requiring the user to perform extensive review of code, low level model design, or technical details of the machine learning project. The system can deploy a virtual sensor to the machine learning project that streams data describing the machine learning project. The data can be streamed in real time or in a low latency manner. Based on this data streaming, graphic representations of the machine learning project can be determined based on the streamed data so that the visual appearance of the graphic representation matches a current configuration of the machine learning project.

An aspect of this technical solution is directed to a system. The system can include a data processing system including one or more processors, coupled with memory, to deploy, for a machine learning project, virtual sensors at a first location of a locations to detect metadata of a data source of the machine learning project, at a second location of the locations to detect deployment information of a model trained for the machine learning project, and at a third location of the locations to detect learning session information for creation of the model. The data processing system can collect, via virtual sensors deployed at the locations, data for the machine learning project. The data processing system can translate, for render on a computing system, the data collected via the virtual sensors into graphics including a graphic representing the metadata of the data source, a graphic representing the deployment of the model, and a graphic representing the learning session.

A virtual sensor of the virtual sensors can monitor values of a data element of the machine learning project. The virtual sensor can stream the values of the data element to the data processing system.

A virtual sensor of the virtual sensors includes a web-hook that monitors a data element of the machine learning project.

The data processing system can apply a visualization rule to the data collected based on a virtual sensor of the virtual sensors, identify a visual appearance of one or more of the graphics based on the visualization rule and the data, and generate the one or more of the graphics to include the visual appearance.

The data processing system can receive, from the computing system, a selection of the graphic representing the learning session and provide, for render on the computing system, entities within the graphic representing the learning session, the entities representing components of the learning session.

The data processing system can determine, based on the data, a health level of a component of the machine learning project, compare the health level to a threshold, and update a visual appearance of at least one of the graphics or connections between the graphics responsive to the health level satisfying the threshold.

The data processing system can determine, based on the data, a health level of a connection of connections between the graphics, compare the health level to a threshold, generate an update to the machine learning project, and modify a visual appearance of the connection.

The learning session can design and train the model of the machine learning project based on a machine learning problem received from the computing system.

The data processing system can generate data causing the computing system to display a time control element, receive a selection of the time control element from the computing system, and animate at least one of the graphics or connections between the graphics based on a historical record of states of the machine learning project at points in time.

The data processing system can animate at least one of the graphics or the connections by adding, removing, or adjusting entities of the graphics based on the historical record.

The graphic representing the metadata of the data source can include a first spherical portion including a metadata entity representing metadata of the data source of the machine learning project. The graphic representing the deployment of the model can be a second spherical portion including a deployment entity representing the deployment of the model trained for the machine learning project.

The data processing system can draw, based on the data, a first connection between the metadata entity and the graphic representing the learning session and a second connection between the graphic representing the learning session and the deployment entity. The first connection and the second connection can indicate that the learning session uses data of the data source to produce the deployment of the model.

The data processing system can generate, based on the data, a third spherical portion, the third spherical portion including a decision entity indicating a decision produced by the deployment of the model of the machine learning project and draw, based on the data, a connection between the deployment entity and the decision entity. The connection indicates that the deployment of the model of the machine learning project produces the decision.

The data processing system can generate the first spherical portion to be a semi-sphere, generate, based on the data, a third spherical portion, the third spherical portion including a decision entity indicating a decision produced by the deployment of the model of the machine learning project, and generate the second spherical portion and the third spherical portion to be quarter-spheres.

An aspect of this technical solution is directed to a method. The method can include deploying, by a data processing system including one or more processors, coupled with memory, for a machine learning project, a virtual sensors at a first location of a locations to detect metadata of a data source of the machine learning project, at a second location of the locations to detect deployment information of a model trained for the machine learning project, and at a third location of the locations to detect learning session information for creation of the model. The method can include collecting, by the data processing system, via the virtual sensors deployed at the locations, data for the machine learning project. The method can include translating, by the data processing system, for render on a computing system, the data collected via the virtual sensors into graphics including a graphic representing the metadata of the data source, a graphic representing the deployment of the model, and a graphic representing the learning session.

A virtual sensor of the virtual sensors monitors values of a data element of the machine learning project and streams the values of the data element to the data processing system.

A virtual sensor of the virtual sensors includes a web-hook that monitors a data element of the machine learning project.

The method can include applying, by the data processing system, a visualization rule to the data collected based on a virtual sensor of the virtual sensors, identifying, by the data processing system, a visual appearance of one or more of the graphics based on the visualization rule and the data, and generating, by the data processing system, the one or more of the graphics to include the visual appearance.

An aspect of this technical solution is directed to a computer readable medium. The computer readable medium can store instructions thereon, that, when executed by one or more processors, cause the one or more processors to deploy, for a machine learning project, virtual sensors at a first location of locations to detect metadata of a data source of the machine learning project, at a second location of the locations to detect deployment information of a model trained for the machine learning project, and at a third location of the locations to detect learning session information for creation of the model. The instructions can cause the one or more processors to collect, via the virtual sensors deployed at the locations, data for the machine learning project. The instructions cause the one or more processors to translate, for render on a computing system, the data collected via the virtual sensors into graphics including a graphic representing the metadata of the data source, a graphic representing the deployment of the model, and a graphic representing the learning session.

A virtual sensor of the virtual sensors can monitor values of a data element of the machine learning project. The virtual sensor of the virtual sensors can stream the values of the data element to the one or more processors.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 is a block diagram of a data processing system that generates a graphic representation of a machine learning project, in accordance with present examples.

FIG. 2 illustrates the graphic representation of the machine learning project of FIG. 1, in accordance with present examples.

FIG. 3 illustrates a graphic representation of data source metadata of the machine learning project of FIG. 1, in accordance with present examples.

FIG. 4 illustrates a graphic representation of deployments and decisions of the machine learning project of FIG. 1, in accordance with present examples.

FIG. 5 illustrates another view of the graphic representation of the machine learning project of FIG. 1, in accordance with present examples.

FIG. 6 illustrates a graphic representation of a learning service of the machine learning project of FIG. 1, in accordance with present examples.

FIGS. 7-8 illustrate a method of performing a learning service for the machine learning project of FIG. 1, in accordance with present implementations.

FIG. 9 illustrates a directed acyclic graph (DAG) of the learning service, in accordance with present examples.

FIG. 10 illustrates a user interface element indicating data for learning sessions of the machine learning project of FIG. 1, in accordance with present examples.

FIG. 11 illustrates a graphic representation of raw metadata entities of the graphic representation of metadata sources of FIG. 3, in accordance with present examples.

FIG. 12 illustrates a graphic representation of derived metadata entities of the graphic representation of metadata sources of FIG. 3, in accordance with present examples.

FIG. 13 illustrates a user interface element for controlling the graphic representation of the machine learning project of FIG. 1, in accordance with present examples.

FIG. 14 illustrates a user interface element representing data sources, in accordance with present examples.

FIG. 15 illustrates a user interface element including data describing the data sources, in accordance with present examples.

FIG. 16 is a user interface element for controlling time in an animation of the graphic representation of the machine learning project of FIG. 1, in accordance with present examples.

FIG. 17 is a method of generating the graphic representation of the machine learning project of FIG. 1, in accordance with present examples.

FIG. 18 is an example of the data processing system of FIG. 1, in accordance with present examples.

FIGS. 19-34 depict display screens or portions thereof with graphical user interfaces, in accordance with present examples.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

This disclosure is generally directed to systems and methods for visualizing a machine learning project. A machine learning project can be a single-objective or multi-objective project that designs, constructs, and deploys multiple models to achieve one or multiple different machine learning goals. The machine learning project can further be designed and managed by one or multiple different users. A user may have difficulty in comprehending the machine learning project due to the expansive and complex nature of the machine learning project. Furthermore, a system that creates visualizations of the machine learning project may not include an efficient method for tracking updates that are made to the machine learning project or the status changes of the machine learning project. Furthermore, these changes to the machine learning project can happen rapidly in real-time and the visualization may not appropriately track the current state of the machine learning project.

To solve these and other technical problems, the system described herein can generate a graphic representation of the machine learning project. The graphic representation can provide both a high level view of the machine learning project and a low level view of various components of the machine learning project. The system can generate a graphic representation in a visual language, e.g., in accordance with a defined set of rules. The visual language can allow for a user to view the graphic representation of the machine learning project and readily understand the current configuration of the machine learning project without requiring the user to perform extensive review of code, low level model design, or technical details of the machine learning project. The graphic can represent high level components of the machine learning project, e.g., metadata of data sources of the machine learning project, learning sessions that design and construct models of the machine learning projects, deployments of the models, and decisions of the models. Within the same graphic, lower level components can be displayed, e.g., individual metadata entities of individual data sources, the various components and pipelines that make up the learning sessions, individual deployments of models and their associated decisions. The lower level components can be included as graphics within graphics representing the higher level components. This allows a user to view a single graphic and zoom in or out to view various levels of the machine learning project without requiring the user to navigate to different user interfaces or screens.

Furthermore, the system can solve technical data collection problems for visualizing the machine learning project by deploying virtual sensors to the machine learning project. The system can deploy a virtual sensor, which can be a portion of code that monitors a data element of the project, to various points in the machine learning project. The virtual sensors can be deployed when the machine learning project is created or over time as new components are added to the machine learning project. The virtual sensors can be web-hooks or web sockets that stream data from the machine learning project to the system. The data can be streamed in real time or in a low latency manner. Based on this data streaming, the system can render the graphic representation of the machine learning project based on the streamed data so that the visual appearance of the graphic representation matches a current configuration of the machine learning project.

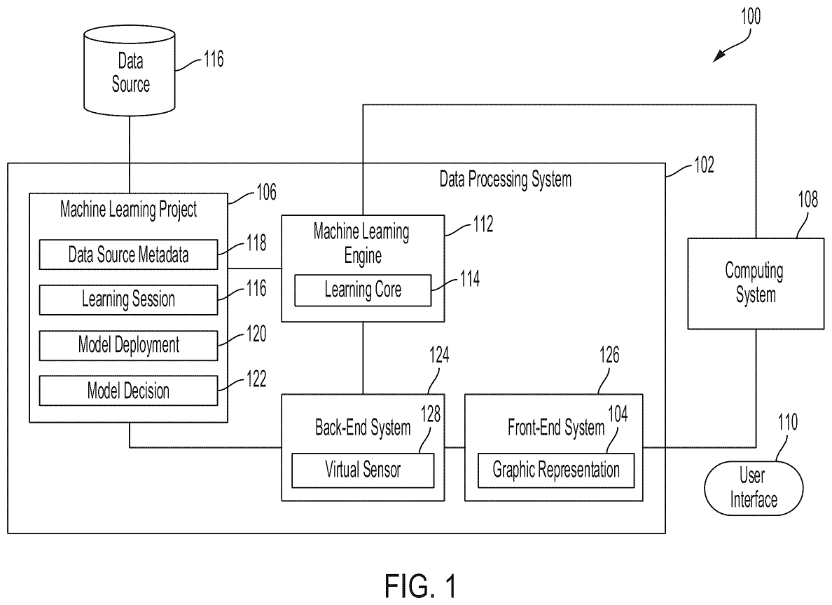

FIG. 1 includes an example system 100 including at least one data processing system 102 that can generate at least one graphic representation 104 of at least one machine learning project 106. The data processing system 102 can communicate with at least one computing system 108. The data processing system 102 can transmit data to the computing system 108, for example, at least one user interface 110. The data processing system 102 can receive data from the computing system 108, for example, user interactions with the user interface 110. The data processing system 102 can generate data that causes the computing system 108 to display the user interface 110. The data processing system 102 can generate data that renders graphic elements, e.g., the graphic representation 104, in the user interface 110.

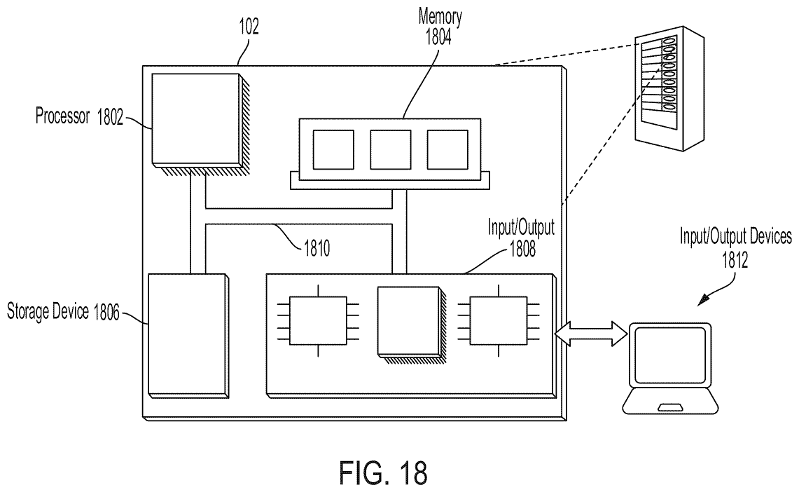

The computing system 108 can be or include a data processing system. Examples of data processing systems are described at FIG. 18. The computing system 108 can be a laptop computer, a tablet computer, a smartphone, a desktop computer. The computing system 108 can include at least one output device, e.g., light emitting diode (LED) displays, organic light emitting diode (OLED) displays, quantum dot LED display (QLED), a liquid crystal display (LCD), etc. The computing system 108 can display the user interface 110 on the output devices for a user or users to view. The computing system 108 can include input devices. For example, the input devices can include a touch-screen, a keyboard, a mouse, a microphone. The input devices can receive input from a user or users.

The data processing system 102 can include various software modules, components, functions, or other computing elements. The data processing system 102 can include various data elements that are stored by the data processing system 102. For example, the data processing system 102 can include a machine learning project 106. The machine learning project 106 can be defined by the computing system 108. For example, a user or multiple users can create or modify the machine learning project 106 via the computing system 108. For example, a user or multiple can provide input via the user interface 110 that defines or otherwise creates the machine learning project 106. The computing system 108 can provide a data problem to be solved or multiple data problems to be solved simultaneously or sequentially. The computing system 108 can provide at least one data set for training machine learning models or algorithms of the machine learning project 106. The computing system 108 can provide data or data sets to be used to generate inferences via the trained machine learning models or algorithms.

The data processing system 102 can include a machine learning engine 112. The machine learning engine 112 can execute at least one learning session 116. The machine learning engine 112 can include a learning core 114 that implements and runs the learning session 116 of the machine learning project 106. The learning session 116 can construct pipelines for the machine learning project 106 based on data provided by the computing system 108. For example, the pipelines can be learning pipelines, training pipelines, and/or inference pipelines. The learning session 116 can perform a search process. The search process can identify a description of a predictive model (e.g., a blueprint, an architecture, a previously trained model) that solves a machine learning problem provided by the computing system 108. The machine learning problem can be a problem to predict, determine, or infer a particular target value of a data set. The learning session 116 can identify or construct a predictive model in a graph format to solve the machine learning problem. The graph can be a DAG that includes nodes representing actions or data and edges between the nodes that represent the order that the actions are performed in. The learning session 116 can design, construct, or train one or multiple models and track the performance of the models over time. The learning session 116 can deploy a highest or high performing model or models (e.g., models that have error rates less than a value or accuracy levels greater than a particular level).

The learning core 114 can execute the learning session 116 to design or train the model based on data of at least one data source 116. The data source 116 can be an external data source to the data processing system 102 or an internal data source to the data processing system 102. The machine learning project 106 can store at least one data source metadata 118 that describes the data source 116. The data source metadata 118 can describe the type of data that the data source 1126 provides. For example, the data source metadata 118 can indicate that the data is category based data, binary data, value data, label data, date data, image data. The data source metadata 118 can indicate that the data is derived data or raw data.

The learning session 116 can produce at least one model deployment 120. The model deployment 120 can be a model designed and trained by the learning session 116. The model deployment 120 can be a model selected from a group of models that is a highest performing model of the group (e.g., is the most accurate model or has the least error rate). The model deployment 120 can be a deployed model that executes on the machine learning engine 112. The model deployment 120 can generate decisions based on data of a data stream or data of a static data source. The model deployment 120 can generate decisions based on data of the data source 116. For example, the model deployment 120 can execute on telemetry data collected from Internet of Things (IoT) devices, web-activity data collected via cookies or tracking pixels, product sales data collected from a product sales platform.

The machine learning project 106 can include at least one model decision 122. The model decision 122 can be a decision of the model deployment 120. The model decision 122 can be a product order decision, a web content delivery decision, an insurance premium decision. The model decision 122 can be provided to various applications internal or external to the data processing system 102. An application can perform actions based on the model decision 122. For example, the application can operate to make purchases of merchandise to fill inventory, generate navigation route suggestions for driving a vehicle, alert a user of predicted security threats in surveillance camera data, etc. The model decision 122 can be provided to the computing system 108 via the user interface 110 by an application or the data processing system 102.

The data processing system 102 includes a back-end system 124 and a front-end system 126. The back-end system 124 can collect and process data for generating the graphic representation 104. The front-end system 126 can generate the graphic representation 104 based on the data collected by the back-end system 124. The back-end system 124 and the front-end system 126 can communicate via application programming interfaces (APIs), publish-subscribe channels, or any other communication protocol. The front-end system 126 can generate the graphic representation 104 by running a two dimensional or three dimensional graphics engine. The front-end system 126 can render the graphic representation 104 to provide a representation of the machine learning project 106 based on the data received from the back-end system 124. The front-end system 126 can run a graphics engine such as the UNREAL ENGINE, UNITY, CRYENGINE.

The graphic representation 104 can include at least one three dimensional or two dimensional graphic element that represents components of the machine learning project 106. The graphic representation 104 can generate the graphic representation 104 to appear as a brain-like structure. The brain-like structure can have a brain-like appearance. For example, the brain-like structure can include two hemispheres and a core between the two hemispheres. The brain-like structure can include at least one semi-sphere, quarter-sphere, eighth-sphere, or any other spherical or sphere shaped portion. The graphic representation 104 can include a graphic representation of the data source metadata 118. The graphic representation 104 of the data source metadata 118 can include a cube, a prism, a sphere, a hemisphere, a quarter-sphere, a spherical portion. The graphic representation 104 of the data source metadata 118 can include entities that represent metadata of individual data sources. For example, a spherical portion can include multiple smaller points or other two dimensional or three dimensional objects that represent the metadata of the individual data sources (e.g., blocks, cubes, rectangles, rectangular solids, stars, diamonds, free form shapes).

The graphic representation 104 can include at least one graphic representation of the learning core 114 or the learning session 116. The graphic representation 104 of the learning core 114 or the learning session 116 can include a cube, a prism, a sphere, a hemisphere, a quarter-sphere, an eighth-sphere, a spherical portion. The graphic representation 104 can include a first sphere that represents the learning core 114. The first sphere can be located in between two semi-spheres. The first sphere can be centered between the two semi-spheres. The graphic representation 104 can include at least one second sphere that represents the learning session 116. The at least one second sphere can be located in between the two semi-spheres. The at least one second sphere can be offset from the first sphere.

The graphic representation 104 can include a graphic representation of the model deployment 120. The graphic representation 104 of the model deployment 120 can include a cube, a prism, a sphere, a hemisphere, a quarter-sphere, an eighth-sphere, a spherical portion. The graphic representation 104 of the model deployment 120 can include entities that represent individual model deployments of models learned or trained by the learning session 116. For example, a spherical portion can include multiple smaller points or other two dimensional or three dimensional objects that represent the individual model deployments (e.g., blocks, cubes, rectangles, rectangular solids, stars, diamonds, free form shapes). The spherical portion can be a quarter-sphere that is located opposite a semi-sphere representing the data source metadata 118.

The graphic representation 104 can include a graphic representation of the model decision 122. The graphic representation 104 of the model decision 122 can include a cube, a prism, a sphere, a hemisphere, a quarter-sphere, an eighth-sphere, a spherical portion. The graphic representation 104 of the model decision 122 can include entities that represent individual model decisions of deployments of models learned or trained by the learning core 114 (e.g., blocks, cubes, rectangles, rectangular solids, stars, diamonds, free form shapes). The individual model decisions can be decisions, inferences, predictions, or categorizations, that the model deployment 120 generates. The graphic representation 104 can include a spherical portion that includes multiple smaller points or other two dimensional or three dimensional objects (e.g., blocks, cubes, rectangles, rectangular solids, stars, diamonds, free form shapes) that represent the individual model decisions 122. The spherical portion can be a quarter-sphere that the front-end system 126 locates opposite a semi-sphere representing the data source metadata 118 in the graphic representation 104. The front-end system 126 can locate the quarter-sphere next to a quarter-sphere representing the model deployment 120 in the graphic representation 104.

The back-end system 124 can include at least one virtual sensor 128. The virtual sensor 128 can be a component of the back-end system 124 that is stored by the back-end system 124. At least a portion of the virtual sensor 128 can be deployed in the machine learning project 106 or the machine learning engine 112. The back-end system 124 can deploy the virtual sensor 128 to the machine learning project 106 when the machine learning project 106 is first created. The back-end system 124 can deploy the virtual sensor 128 to the machine learning project 106 as updates are made to the machine learning project 106. For example, if a new learning session 116 is implemented, the back-end system 124 can deploy the virtual sensor 128 to the new learning session 116 to monitor data of the new learning session 116. One virtual sensor 128 deployed by the back-end system 124 can monitor the creation of new data elements in the machine learning project 106. Based on an indication of the creation of new data elements in the machine learning project 106 received from the one virtual sensor 128, the back-end system 124 can deploy additional virtual sensors 128 to monitor the new data elements.

The virtual sensor 128 can collect data for various data points, data registers, data elements, data locations, data pointers of the machine learning project 106. The virtual sensor 128 can be a web-hook or web socket. The virtual sensor 128 can read, retrieve, or monitor data values or data elements of the machine learning project 106 or the machine learning engine 112. The virtual sensors 128 can be stored at various locations within the machine learning project 106 or the machine learning engine 112 that allow the virtual sensors 128 to monitor and detect information associated with the machine learning project 106 (e.g., the data source metadata 118, the learning session 116, the model deployment 120, the model decision 122, the learning core 114). The virtual sensors 128 can identify changes to the data values or data elements that indicate changes to the data source metadata 118, the learning session 116, the model deployment 120, the model decision 122, or the learning core 114. The changes to the machine learning project 106 can be streamed as one or more data streams, e.g., event streams, data streams, value streams, to the back-end system 124. The back-end system 124 can provide the data streams to the front-end system 126.

The front-end system 126 can modify the appearance of the graphic representation 104 based on the data of the data streams. For example, the front-end system 126 can identify new, deleted, or modified elements of the data source metadata 118, the learning sessions 116, the model deployments 120, or the model decisions 122 based on the data streams. The front-end system 126 can translate the data received from the back-end system 124 into a visual language that the front-end system 126 uses to generate the graphic representation 104 or causes the graphic representation 104 to be rendered by the computing system 108. For example, the front-end system 126 can include a set of rules that define the visual language for the appearance of the graphic representation 104. The front-end system 126 can apply the data received from the virtual sensor 128 to the set of rules to determine whether to update, modify, or add to the visual appearance of the graphic representation 104. Applying the set of rules can translate values of the data received from the back-end system 124 into visual representations in the graphic representation 104. The front-end system 126 can add new graphics, delete existing graphics, or modify existing graphics within the graphic representation 104 to represent the changes. For example, the front-end system 126 can add a new metadata entity to represent a new data source or delete the metadata entity responsive to detecting that the data source is deleted or removed from the machine learning project 106. Furthermore, the front-end system 126 can draw lines connecting the entities representing relationships between the various components of the machine learning project 106. As the relationships are added, removed, for modified, the front-end system 126 can modify the lines drawn in the graphic representation 104.

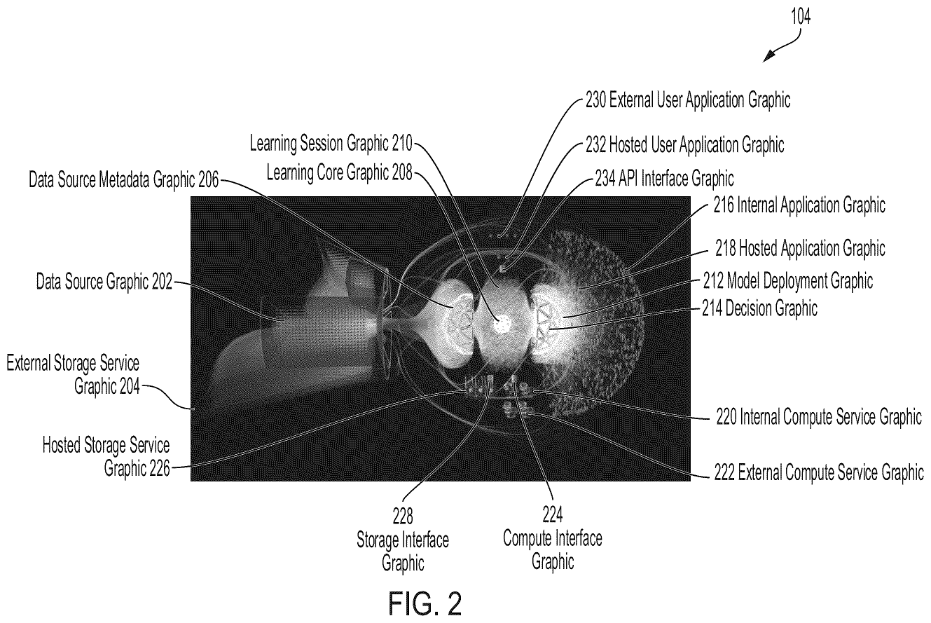

FIG. 2 illustrates an example of the graphic representation 104 of the machine learning project 106. The graphic representation 104 can include various three dimensional graphic elements that describe the machine learning project 106. For example, the graphic representation 104 can include at least one data source graphic 202 that represents the data source 116. The data source graphic 202 can be a three dimensional solid. For example, the data source graphic 202 can be a cylinder, a prism, a sphere, or any other shape. The data source graphic 202 can include entities within the three dimensional solid that represent individual data sources 106. For example, the entities can be two dimensional or three dimensional shapes or solids, e.g., squares, cubes, rectangles, stars, prisms, diamonds.

The graphic representation 104 can include at least one connection drawn to connect entities of the data source graphic 202 to entities of an external storage service graphic 204. The external storage service graphic 204 can represent a data storage service that stores the data sources 104. For example, the external storage service can be a database service of a computing system such as a server, a desktop computer, a cloud system. The external storage service graphic 204 can be a three dimensional solid, for example, a cylinder, a prism, a sphere, or any other shape. The external storage service graphic 204 can include entities within the three dimensional solid that represent individual data storage services. For example, the entities can be two dimensional or three dimensional shapes or solids, e.g., squares, cubes, rectangles, stars, prisms, diamonds. The graphic representation 104 can include connection lines that connect the entities of the external storage service graphic 204 with entities of the data source graphic 202. The lines can indicate relationships between the entities, e.g., one entity represents a data storage service that is related to a second entity representing a data source that the data storage service manages. The graphic representation 104 can include a line that connects the first entity with the second entity.

The graphic representation 104 can include at least one data source metadata graphic 206. The data source metadata graphic 206 can represent the data source metadata 118. The data source metadata graphic 206 include a three dimensional solid, for example, a cylinder, a prism, a sphere, or any other shape. The data source metadata graphic 206 can include entities that represent individual data source metadata 206. The entities representing the individual data source metadata 206 can include two dimensional or three dimensional shapes or solids, e.g., squares, cubes, rectangles, stars, prisms, diamonds. The entities representing the individual data source metadata 206 can be connected to entities of the data source graphic 202 via connectors drawn between the entities of the data source metadata 206 and the entities of the data source graphic 202. For example, one particular metadata entity may represent metadata for one particular data source entity. The graphic representation 104 can include a line drawn between the two entities to represent the relationship between the two entities.

The graphic representation 104 can include at least one learning core graphic 208. The learning core graphic 208 can represent the learning core 114. The learning core graphic 208 can represent a capability (e.g., an ability, a software application or function, the availability of) of the machine learning project 106 to run or execute the learning core 114 to perform learning sessions 116 to create model deployments 120. The learning core graphic 208 can be a three dimensional solid, for example, a cylinder, a prism, a sphere, or any other shape. The learning core graphic 208 can be surrounded by at least one learning session graphic 210. The learning session graphic 210 can represent the learning session 116. The learning session graphic 210 can be a three dimensional solid, for example, a cylinder, a prism, a sphere, or any other shape. The learning session 210 can be connected to entities of the data source metadata graphic 206. For example, one or multiple entities that represent data source metadata for data sources that the learning session uses to performing learning or training can be connected to the learning session graphic 210 via connectors.

The graphic representation 104 can include at least one model deployment graphic 212 and at least one decision graphic 214. The model deployment graphic 212 can represent the model deployment 120. The decision graphic 214 can represent the model decision 122. The model deployment graphic 212 and the model decision graphic 214 include be a three dimensional solid, for example, a cylinder, a prism, a sphere, or any other shape. The model deployment graphic 212 and the decision graphic 214 can be combined into a single shape, e.g., quarter-spheres combined into a semi-sphere. The semi-sphere can be located opposite another semi-sphere, e.g., the data source metadata graphic 206. The model deployment graphic 212 can include entities that represent individual model deployments 120. The entities can be two dimensional or three dimensional shapes or solids, e.g., squares, cubes, rectangles, stars, prisms, diamonds. The entities of the model deployment graphic 212 can be connected to the learning session graphic 210 representing the learning session that created the model deployment. For example, an entity representing a model deployment can be connected via a line between the entity and the learning session graphic 210 that represents the learning session that produced the model deployment.

The graphic representation 104 can include at least one internal application graphic 216 representing an internal application (e.g., internal to the data processing system 102 or the machine learning project 106) that runs operations based on the model decisions 122. The graphic representation 104 can include at least one hosted application graphic 218 representing a hosted application (e.g., external to the data processing system 102 or the machine learning project 106 hosted on a remote server or computer system) that runs operations based on the model decisions 122. The internal application graphic 216 or the hosted application graphic 218 can include two dimensional or three dimensional shapes or solids, e.g., squares, cubes, rectangles, stars, prisms, diamonds. The internal application graphic 216 or the hosted application graphic 218 can be connected to the model deployment graphic 212 or the decision graphic 214 via lines. For example, the lines can indicate that a particular application consumes or operates on outputs of a particular model deployment or operates on particular decisions. The lines can connect the internal application graphic 216 or the hosted application graphic 218 to a particular entity representing a particular model deployment in the model deployment graphic 212 or a particular entity representing a decision of a model deployment of the decision graphic 214.

The graphic representation 104 can include at least one internal compute service graphic 220 that represents computational resources (e.g., processors, graphics processing units, application specific integrated circuits, memory, etc.) internal to the data processing system 102 that execute the machine learning project 106. The graphic representation 104 can include at least one external compute service graphic 222 that represents computational resources (e.g., processors, graphics processing units, application specific integrated circuits, memory) external to the data processing system 102 that can be included in one or more remote servers or computing systems that execute the machine learning project 106. The graphic representation 104 includes a compute interface graphic 224 that represents a piece of software or code that serves as an interface between the machine learning project 106 and the internal or external compute services represented by the internal compute service graphic 220 or the external compute service graphic 222. The compute interface graphic 224 can include two dimensional or three dimensional shapes or solids, e.g., squares, cubes, rectangles, stars, prisms, diamonds, cylinders.

The graphic representation 104 can include at least one hosted storage service graphic 226. The hosted storage service graphic 226 can represent a hosted storage service that stores the data source 116. The hosted storage service can be a storage service located remote from the data processing system 102. For example, the hosted storage service can be hosted on an external server or computer system. The hosted storage service represented by the hosted storage service graphic 226 can interface with the machine learning project 106 via a storage interface. The graphic representation 104 can include at least one storage interface graphic 228. The storage interface graphic 228 can represent the storage interface. The storage interface can be an application or code that interfaces the data source 116 with the data processing system 102. The storage interface graphic 228 can include two dimensional or three dimensional shapes or solids, e.g., squares, cubes, rectangles, stars, prisms, diamonds, cylinders.

The graphic representation 104 can include at least one external user application graphic 230 and at least one hosted user application graphic 232. The external user application graphic 230 can represent a user application that is external to the machine learning project 106. The application can be an application that allows the computing system 108 to interact with the machine learning project 106, e.g., provide design inputs or modify the machine learning project 106. The hosted user application graphic 232 can represent a user application that is hosted on an external server or computing system. The user application can be an application that allows the computing system 108 to interact with the machine learning project 106, e.g., provide design inputs or modify the machine learning project 106. The graphic representation 104 includes an API interface graphic 234. The API interface graphic 234 can represent an API which the external or hosted user applications represented by the external user application graphic 230 or the hosted user application graphic 232 communicate with to interface and interact with the machine learning project 106.

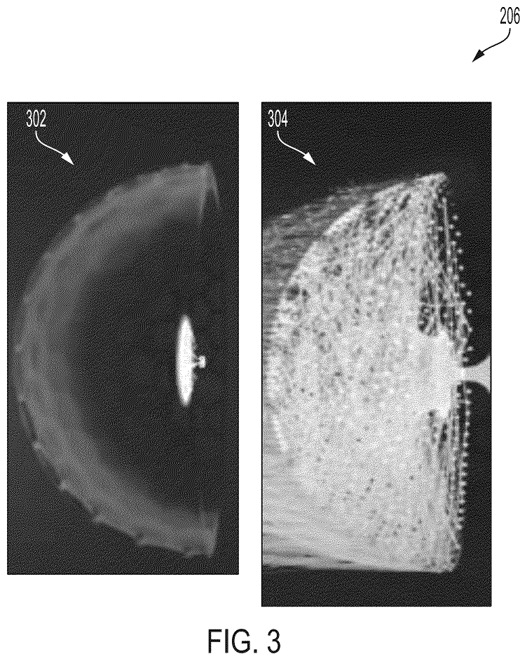

FIG. 3 illustrates example graphic representations of the data source metadata graphic 206 representing the data source metadata 118 of the machine learning project 106. FIG. 3 includes at least one graphic 302. The graphic 302 can include at least one spherical portion (e.g., a semi-sphere). The graphic 302 illustrates an example of the data source metadata graphic 206 without any entities or connections between entities. A user can provide an input via the computing system 108 to turn on or off the entities or connections. For example, a user can interact with a single entity via the computing system 108. Responsive to the interaction, the front-end system 126 can hide or de-emphasis (e.g., make transparent) other entities or connections that are separate from the entity that the user interacted with. The front-end system 126 can emphasis the entity that the user interacted with or emphasis connections of the entity with other entities, e.g., change the entity or connections to a darker or vibrant color).

The graphic 302 can illustrate an example of the data source metadata graphic 206 at a first point in time when the machine learning project 106 is early in its development. Before a user provides data sources 116 to the machine learning project 106, the front-end system 126 can render the graphic 302 to not include any entities to illustrate that the user has not added any data sources 116 to the machine learning project 106. At a later point in time, as a user adds the data sources 116 to the machine learning project 106, the front-end system 126 can add entities to the data source metadata graphic 206 to represent the added data source metadata 118, e.g., create the graphic 304. The front-end system 126 can draw connections between the entities of the graphic 304 and other graphics, e.g., the data source graphic 202 or the learning session graphic 210. For example, the front-end system 126 can draw a connection between an entity representing a particular data source of the data source graphic 202 and an entity of the graphic representing metadata for the particular data source. The front-end system 126 can draw a connection between the entity representing the particular data source and a particular learning session graphic 210 that represents a learning session that consumes the data of the particular data source.

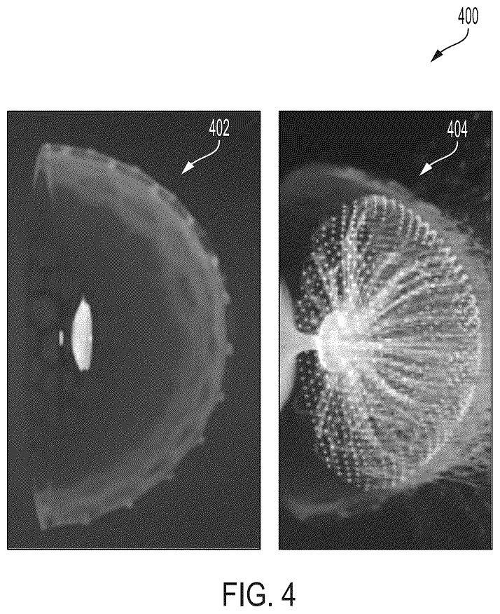

FIG. 4 illustrates an example of a graphic representation 400 representing deployments and decisions of the machine learning project 106. FIG. 4 includes a graphic 400 that can be a spherical portion (e.g., a semi-sphere) that includes the model deployment graphic 212 and the decision graphic 214. The graphic 400 can include the model deployment graphic 212 as a first quarter-sphere and the decision graphic 214 as a second quarter-sphere. The graphic 400 can include no entities or connections as shown in at least one graphic 402. The graphic 400 can include entities and connections as shown in at least one graphic 404.

The graphic 403 provides an example of the graphic 400 when no entities or connections are displayed. For example, a user can provide an input via the computing system 108 to hide the entities or connections. At a particular point in time, before a learning session 116 has finished creating a model deployment 120 and no model decision 122 has been made, the front-end system 126 can render the graphic 402 to illustrate that the machine learning project 106 does not yet have any model deployments 120 or model decisions 122. As the learning sessions 116 are instantiated by the machine learning engine 112 and model deployments 120 are generated, the front-end system 126 can add entities to the graphic 402, creating the graphic 404, which includes entities to represent model deployments 120 and model decisions 122 of the model deployments 120.

The graphic 404 can include connections between the entities of the graphic 404. For example, a first entity that represents a particular model deployment 120 can be connected via a line drawn by the front-end system 126 to a second entity that represents a model decision 122 made by the particular model deployment 120. This example connection can be included within the spherical portion of the graphic 404. Furthermore, the front-end system 126 can draw connections between the entities of graphic 404 and other graphics. For example, an application represented by the internal application graphics 216 or the hosted application graphics 218 can consume a particular model decision represented by an entity within the graphic 404. The front-end system 126 can draw a line between the entity and the internal application graphics 216 or the hosted application graphics 218 to represent that the applications consume the model decision represented by the entity.

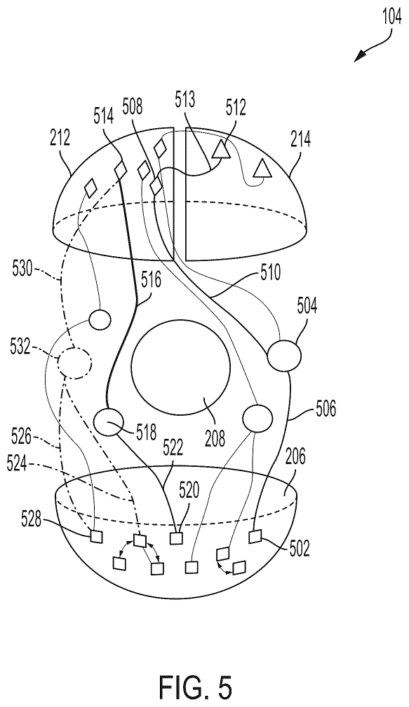

FIG. 5 illustrates an example of the graphic representation 104 of the machine learning project 106. The graphic representation 104 can include the data source metadata graphic 206 as a semi-sphere. The graphic representation 104 can include the model deployment graphic 212 as a quarter-sphere located opposite the semi-sphere. The graphic representation 104 can include the decision graphic 214 as another quarter-sphere located opposite the semi-sphere of the data source metadata graphic 206. The quarter-spheres can be located together forming a second semi-sphere opposite the semi-sphere of the data source metadata graphic 206. The graphic representation 104 can include the learning core graphic 208 as a sphere located between the two semi-spheres.

The data source metadata graphic 206 can include at least one entity. The data source metadata graphic 206 can include an entity 502 representing metadata of a particular data source. The graphic representation 104 includes a graphic 504 representing a particular learning session 116. The particular learning session 116 can consume the data of the data source. To represent this relationship, the graphic representation 104 can include a connection 506 drawn between the entity 502 and the graphic 504. The particular learning session 116 can use the data of the data source to perform a learning session where a training or inference pipeline is produced. The training pipeline can produce a particular model deployment 120, e.g., an inference pipeline. The particular model deployment 120 can be represented as an entity 508 within the model deployment graphic 212. To represent that the learning session 116 produces the particular model deployment 120, the graphic representation 104 can include a connection 510 between the graphic 504 and the entity 508. The particular model deployment 120 can create outputs based on input data fed into the particular model deployment 120. The outputs can be model decisions (e.g., predictions, inferences, categorizations). The model decision 122 of the particular model deployment 120 can be represented as entity 512 included within the decision graphic 214. To represent that the particular model deployment 120 produces the model decision, the graphic 104 can include a connection 513 between the entity 508 and the entity 512.

The back-end system 124 can monitor the health of the machine learning project 106. For example, the back-end system 124 can determine a health level of data of the data source 116, of a learning session 116, of a model deployment 120, or a model decision 122. For example, the back-end system 124 can generate health scores for the various components of the machine learning project 106 and compare the health scores to a threshold. Responsive to identifying that the health scores satisfy the threshold (e.g., the health scores are greater than the threshold), the back-end system 124 can identify an issue and cause the front-end system 126 to modify the appearance of the graphic representation 104 to indicate the issue.

For example, the back-end system 124 can identify a health level of a model deployment 120 by comparing model decisions 122 of the model deployment 120 to truth data. The back-end system 124 can identify error levels with the model decisions 122. Responsive to the error levels satisfying a threshold, e.g., being greater than a particular level, the front-end system 126 can modify the appearance of the graphic representation 104 to represent the health issue. For example, if the health level of a model deployment represented by an entity satisfies a threshold, a connection 516 between a graphic 518 that represents a learning session that produces the model deployment represented by the entity 514 can be highlighted (e.g., bolded, colored red, animated to flash). The learning session represented by the graphic 518 can consume data of a data source. The metadata of the data source can be represented as entity 520 and the consumption of the data by the learning session can be represented by the connection 522 between the entity 520 and the graphic 518. The connection 516 can be highlighted by changing a color of the connection 516 (e.g., changing the color from black to red) or changing a thickness of the connection 516 (e.g., increasing the thickness).

The machine learning engine 112 can respond to the health issue of the model deployment. For example, the machine learning engine 112 can instantiate a new learning session to replace the learning session represented by the graphic 518 to improve the performance of the model deployment represented by the entity 514. The back-end system 124 can identify the instantiation of the new learning session 116 and can modify the graphic representation 104 to include a new graphic 532 to represent the new leaning session 116. The graphic representation 104 can include a connection 524 between the entity 520 and the graphic 532 indicating that the learning session represented by the graphic 518 consumes data of a data source which has its metadata represented by entity 520. The learning session represented 532 can identify that additional data is needed for the model deployment 514. The graphic representation 104 can draw a connection 526 between the graphic 532 and an entity 528 representing metadata of the additional data. The graphic representation 104 can draw a connection 530 between the graphic 532 and the entity 514 representing that the learning session represented by the graphic 518 is producing the model deployment represented by the entity 514. Responsive to the new learning session being instantiated and replacing the learning session represented by the graphic 518, the front-end system 126 can remove the connection 516, the graphic 518, and the connection 522 from the graphic representation 104.

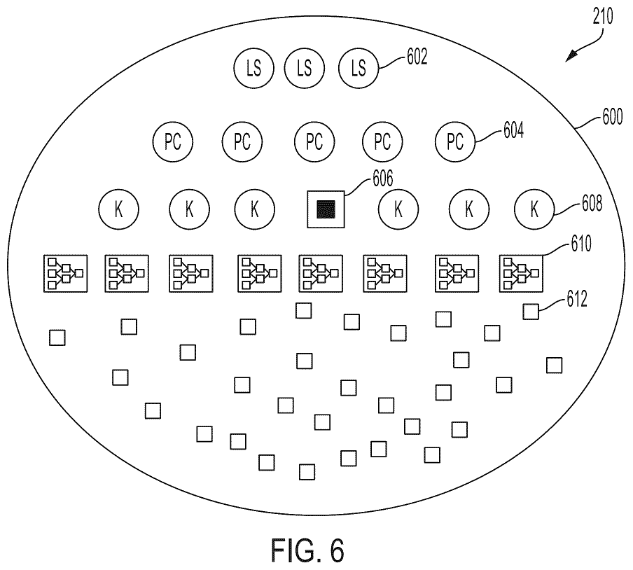

FIG. 6 illustrates an example of the learning session graphic 210 of the machine learning project of 106. The learning session graphic 210 can include various graphic components (e.g., sub-components or sub-entities) representing components of the learning session 116. The graphic components can be two dimensional or three dimensional graphic components, e.g., spheres, alpha-numeric letters, cubes, DAGs. For example, learning session 116 can include at least one learning strategy represented by at least one graphic 602. The learning strategy can include a set of instructions to perform meta-learning. The set of instructions can indicate steps to identifying template learning pipelines, adjustments to learning pipelines, constructing inference pipelines. The set of instructions can indicate steps for identifying the appropriate models or model types used in a previous project that are applicable for another project that the learning session is implemented for.

The learning session 116 includes at least one pipe constructor represented by graphic 604. The pipeline constructor can be a piece of code that builds pipelines of the learning session 600. For example, the pipeline constructor can build pipelines for training or inference, e.g., DAGs that represent the steps of training of a model or generating inferences by the model. The pipelines can be represented as at least one graphic 610 in the learning session graphic 210. The learning session 116 can include pointer to a repository of experiments. The experiments can be experiments that test whether certain model architectures or training methodologies that solve various machine learning problems. The pointer can be represented as an element 606. Knowledge retrieved from the repository via the pointer can be included within the learning session 116 and represented as at least one graphic 608. The learning session 116 can include various tasks that can be represented as at least one graphic 612.

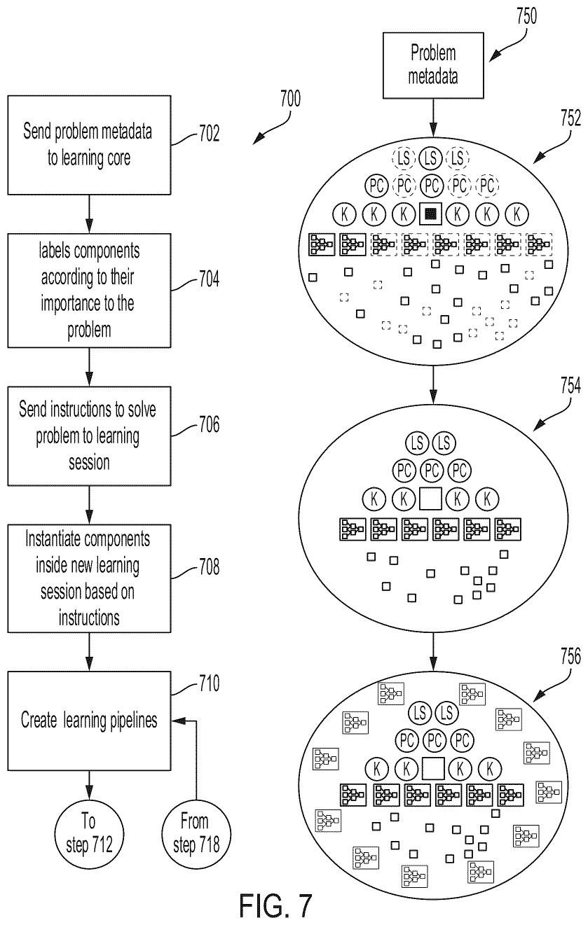

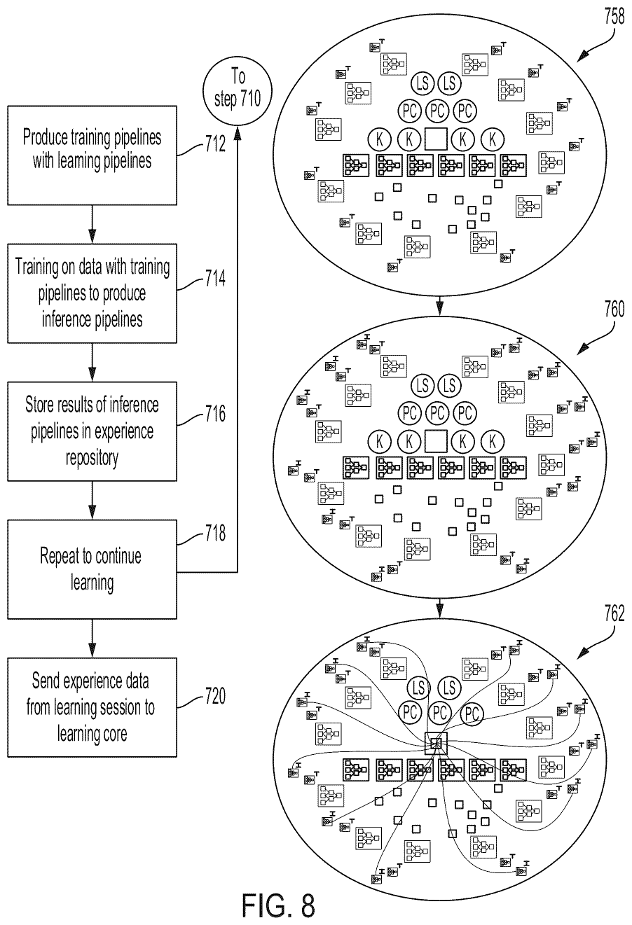

FIGS. 7-8 illustrates an example of a method 700 of performing a learning service. The data processing system 102 can store instructions on memory devices that cause at least one processor of the data processing system 102 to perform the method 700. Any computing system or device described herein can execute the method 700. The method 700 includes an ACT 702 of sending problem metadata to a learning core. The method 700 includes an ACT 704 of labeling components according to their importance to the problem. The method 700 includes an ACT 706 of sending instructions to solve the problem to a learning session. The method 700 includes an ACT 708 of instantiating components inside a new learning session based on the instructions. The method 700 includes an ACT 710 of creating learning pipelines. The method 700 includes an ACT 712 of producing training pipelines with the learning pipelines. The method 700 includes an ACT 714 of training on data with the learning pipelines to produce inference pipelines. The method 700 includes an ACT 716 of storing results of inference pipelines in an experience repository. The method 700 includes an ACT 718 of repeating at least one of ACTS 710-716 to continue a learning process. The method 700 includes an ACT 720 of sending experience data from the learning session to the learning core.

The method 700 can be performed by the data processing system 102, e.g., by the machine learning project 106 (e.g., the learning session 116) or the machine learning engine 112 (e.g., the learning core 114). As the data processing system 102 performs the method 700, the virtual sensor 128 can monitor the performance of the method 700 and generate data indicating changes made to learning, training, inferences, or model deployment. The front-end system 126 can modify the graphic representation 104 as the data processing system 102 performs the method 700 to align the graphic representation 104 with the current actions being performed by the data processing system 102. A visual representation of the learning session 116 can be modified by the front-end system 126 as illustrated by the changes to the graphics 752-762.

At ACT 702, the method 700 can include sending, by the data processing system 102, problem metadata to the learning core 114. The problem metadata can describe a machine learning problem. For example, the problem metadata can indicate a variable or parameter of a data set that a machine learning model is intended to predict or determine. The problem metadata can be generated by a user via the computing system 108 and provided to the learning core 114 by the data processing system 102.

At ACT 704, the method 700 can including labeling, by the data processing system 102, components available for a learning session according to their importance to the problem indicated by the problem metadata. For example, the learning core 114 can analyze a repository of records of other machine learning projects, the training algorithms used in the other projects, the model architectures used in the other projects to identify components that are important or relevant for solving the problem. The learning core 114 can identify learning strategies, pipeline constructors, pipelines, tasks, or knowledge that is important or relevant for solving the problem. The learning core 114 can rank the various components according to their important or relevance for solving the problem and select a set of high ranking components (e.g., a set of the highest ranking components). The front-end system 126 can generate the graphic 752 including various components. The front-end system 126 can highlight the components in the graphic 752 that the learning core 114 selects as being important to solving the machine learning problem.

At ACT 706, the method 700 can include sending, by the data processing system 102, instructions to solve the problem to a learning session. For example, the learning core 114 can send the instructions to the machine learning engine 112 or the machine learning project 106 to instantiate a learning session 116 including the components identified at ACT 704. At ACT 708, the method 700 can include instantiating, by the data processing system 102, components inside a new learning session 116 based on the instructions received at ACT 706. The data processing system 102 can instantiate the learning session 116 in the machine learning project 106. The data processing system 102 can cause the learning session 116 to include the components identified at the ACT 704. Responsive to the learning session 116 being instantiated, the front-end system 126 can generate the graphic 754. The graphic 754 can be a new graphic representing the instantiated learning session 116. The graphic 754 can be a modified version of the graphic 752. For example, the front-end system 126 can add or remove components from the graphic 752 to create the graphic 754. The graphic 754 can include a reorganization of the components identified at ACT 704.

At ACT 708, the method 700 can include creating, by the data processing system 102, learning pipelines. The learning pipelines can be DAGs. The learning pipelines can lay out a set of steps for selecting model architectures, training the model architectures, comparing the performance of the various model architectures, and selecting a model for implementation. The learning pipeline can further include training pipelines. The training pipelines can indicate the steps of identifying parameter values for training a machine learning model. Furthermore, the pipelines can include inference pipelines. The inference pipelines can be executions of the machine learning model to generate an output, e.g., a decision, a prediction, and inference. The front-end system 126 can update the graphic 754 to include components representing the various pipelines created at step 710.

At ACT 712, the method 700 can include producing, by the data processing system 102, training pipelines with the learning pipelines created at the ACT 710. The learning pipelines, when executed, can create training pipelines for training particular models. For example, the learning pipelines can identify a model architecture to be trained that can solve the machine learning problem. The learning pipeline can produce a training pipeline that trains an instance of the model architecture. The learning pipeline can identify hyper-parameters for the training pipeline, training algorithms for the training pipeline, configurations of the training algorithms. The front-end system 126 can create new components within the graphic 758 to represent the training pipelines that the data processing system 102 produces.

At ACT 714, the method 700 can include training, by the data processing system 102, based on data with the training pipelines to produce inference pipelines. The data processing system 102 can produce an inference pipeline for each training pipeline. The inference pipeline can be a set of steps that execute a machine learning model trained according to the training pipeline. The front-end system 126 can create new components within the graphic 760 to represent the inference pipelines that the data processing system 102 produces.

At ACT 716, the method 700 can include storing, by the data processing system 102, results of the inference pipelines in an experience repository. The experience repository can include data that indicates the training steps taken to produce inference pipelines or train models. The experience repository can indicate the inference pipelines or trained models. The results can indicate the performance of the various training methodologies and model architectures. The front-end system 126 can draw lines in the graphic 762 between the inference pipelines and a component of the graphic 762 representing a link to the experience repository to indicate that the inference pipelines have been stored in the experience repository.

At ACT 718, the method 700 can include repeating, by the data processing system 102, one or more steps of the method 700 to continue learning. The repeated learning can build off of the knowledge stored in the experience repository at ACT 716. For example, the data processing system 102 can identify that certain types or structures of machine learning models that produced high performing results (e.g., results that meet a threshold.). At ACT 720, the method 700 can include sending, by the data processing system 102, the experience data from the learning session 116 to the learning core 114. The data processing system 102 can send the experience data to the learning core 114 responsive to completing a learning process, e.g., completing steps 702-720. The learning core 114 can use the experience data for perform future learning sessions. The experience data can be the results store din the experience repository at ACT 716.

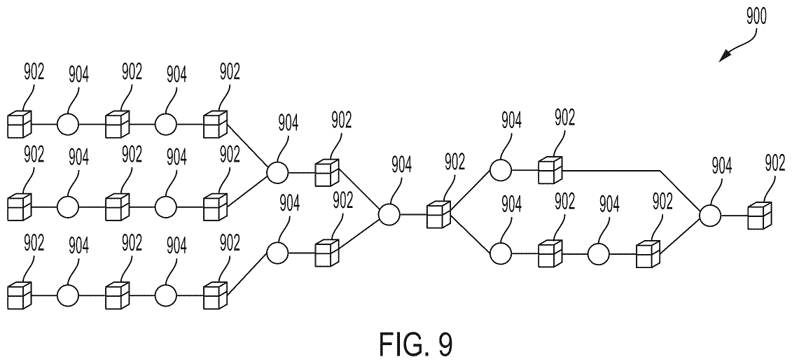

FIG. 9 illustrates an example of a DAG 900 of the learning session 116. The DAG 900 can include be a learning pipeline, a training pipeline, or an inference pipeline. The DAG 900 can be displayed as a graphical component or set of components within a graphic representation such as the graphic 600. The DAG 900 can be a zoomed in version of the graphic 610. The DAG 900 can include data elements 902 representing data that is processed or derived. The DAG 900 can include actions 904. The actions can be computational actions such as computing functions, computing tasks, calculations, etc. that are performed on the data elements 902.

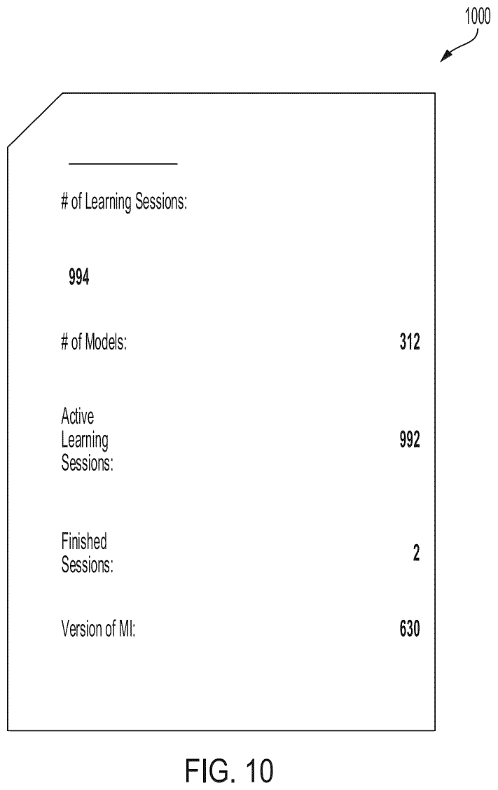

FIG. 10 illustrates an example of a user interface element 1000 indicating data for the learning sessions 116 of the machine learning project 106. The user interface element 1000 can be displayed within the user interface 110. The user interface element 1000 can be generated by the front-end system 126 to represent the status or description of the learning sessions 116. The front-end system 126 can collect data from the machine learning project 106 indicating a number of the learning sessions 116, a number of models produced by the learning sessions 116, a number of active learning sessions 116, a number of finished learning session 116, and a number of versions. The front-end system 126 can cause the collected data to be included within the user interface element 1000.

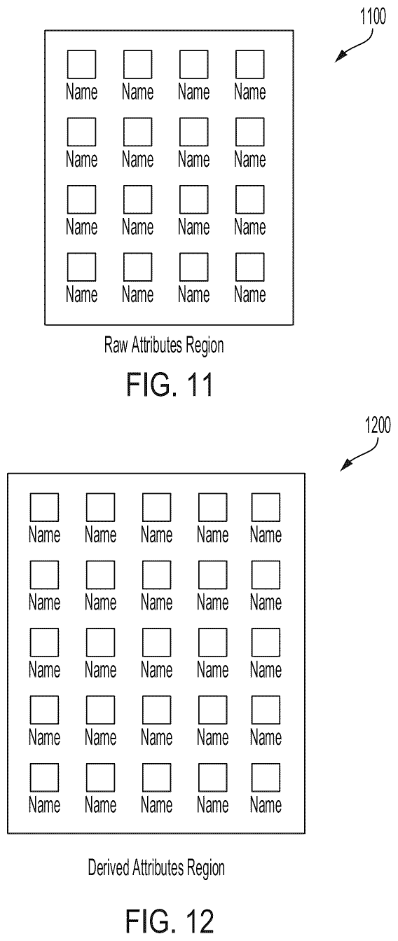

FIG. 11 illustrates an example of a graphic representation 1100 of raw metadata entities of the data source metadata graphic 206. The graphic representation 1100 can be rendered on the computing system 108 responsive to a user interacting with the data source metadata graphic 206. For example, a user can interact with the data source metadata graphic 206 and an expanded or zoomed in version of the data source metadata graphic 206 can be rendered including the graphic representation 1100. The graphic representation 1100 can be a grid of elements or entities in two dimensions or three dimensions, rows of elements, or a free form shape of elements (e.g., the elements can be located in pseudo-random locations).

Each element of graphic representation 1100 can be named and can include a visual representation. The visual representation can include a color, shape, or size. The visual representation can be set based on the data type of represented by the element. For example, the element can represent categorical data, numeric data, a date, text, an image. The visual appearance can further indicate whether the element represents a high value (e.g., a highest value in a set), a low value (e.g., a lowest value in a set), an indication of a target value that the machine learning project 106 is determining or a key value that has a significant impact on the determinations of the machine learning project 106.

FIG. 12 illustrates an example of a graphic representation 1200 of derived metadata entities of the data source metadata graphic 206. The graphic representation 1200 can be rendered on the computing system 108 responsive to a user interacting with the data source metadata graphic 206. For example, a user can interact with the data source metadata graphic 206 and an expanded or zoomed in version of the data source metadata graphic 206 can be rendered including the graphic representation 1200. The graphic representation 1200 can be a grid of elements in two dimensions or three dimensions, rows of elements, or a free form shape of elements (e.g., the elements can be located in pseudo-random locations). The individual elements of the graphic representation 1200 can include a visual representation representing the type of data or other features of the data, for example, indicating whether the data element is categorical data, numeric data, a date, text, an image, etc. The visual appearance can further indicate whether the element represents a high value (e.g., a highest value in a set), a low value (e.g., a lowest value in a set), an indication of a target value that the machine learning project 106 is determining or a key value that has a significant impact on the determinations of the machine learning project 106.

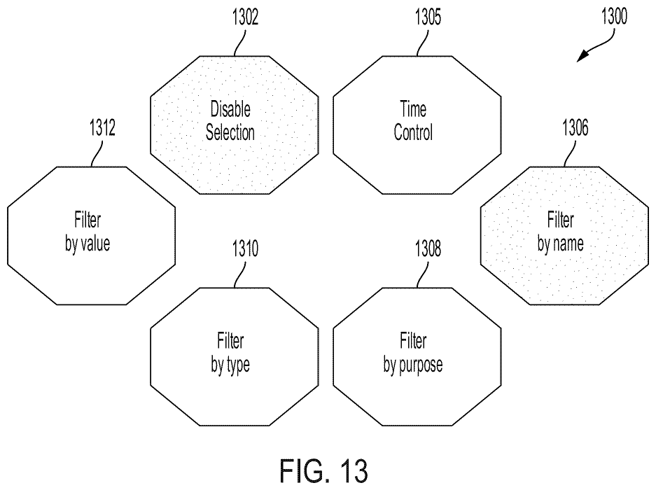

FIG. 13 illustrates an example of a user interface element 1300 for controlling the graphic representation of the machine learning project 106. The user interface element 1300 can be included within the user interface 110 and displayed by the computing system 108. The user interface 1300 includes control elements 1302-1312. The control elements 1302-1312 can include a disable selection element 1302. Responsive to interacting with the disable selection element 1302, the ability to select components of the graphic representation 104 can be disabled. This can allow a user to pan, zoom, or tilt the graphic representation 104 on a display of the computing system 108 without accidently making selections of the components of the graphic representation 104.

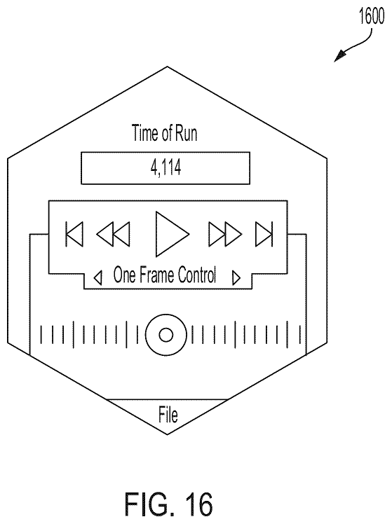

The control element 1304 can be a time control element that allows a user to move forward, backwards in time, or pause the passage of time relative to the graphic representation 104. For example, the front-end system 126 can store a historical record of the graphic representation 104 that a user can rewind and play back on the computing system 108. Responsive to interacting with the control element 1304, an element 1600 discussed for example at FIG. 16 can be displayed in the user interface 110. The control element 1306 can filter components of the graphic representation 104 by name. For example, the front-end system 126 can filter entities of the data source metadata graphic 206 based on based on the name of each entity.

The control element 1308 can filter components of the graphic representation 104 by purpose. For example, the front-end system 126 can filter entities of the data source metadata graphic 206 based on purpose each entity, e.g., whether the entity represents data being predicted, used for training, used for making an inference. The control element 1310 can filter components of the graphic representation 104 by type. For example, the front-end system 126 can filter entities of the data source metadata graphic 206 based on type each entity, e.g., whether the entity represents data of various types including audio, numeric, categorical, text, date, date duration, image, category, geospatial. The control element 1312 can filter components of the graphic representation 104 by value. For example, the front-end system 126 can filter entities of the data source metadata graphic 206 based on the value each entity, e.g., filter out entities representing data values below a threshold, above a threshold, within thresholds.

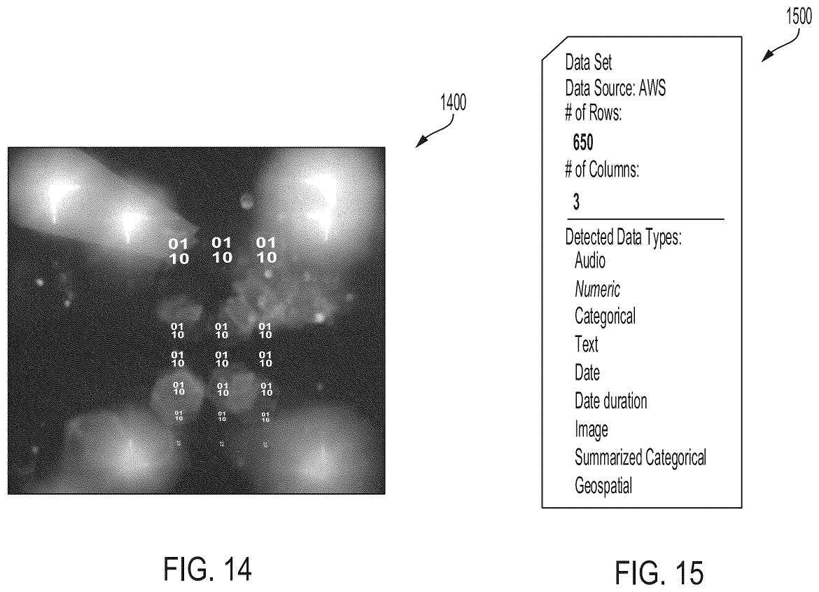

FIG. 14 illustrates an example of a user interface element 1400 representing data sources. The graphic representation 1400 can be rendered on the computing system 108 responsive to a user interacting with the data source graphic 202. For example, a user can interact with the data source graphic 202 and an expanded or zoomed in version of the data source graphic 202 can be rendered including the graphic representation 1400. The graphic representation 1400 can be a grid of elements in two dimensions or three dimensions, rows of elements, or a free form shape of elements (e.g., the elements can be located in pseudo-random locations).

FIG. 15 illustrates an example of a user interface element 1500 including data describing the data sources. The user interface element 1500 can be displayed within the user interface 110. The user interface element 1500 can be generated by the front-end system 126 to represent data of a particular data source represented as an entity within the data source graphic 202. The front-end system 126 can collect data from the machine learning project 106 indicating a name of a data source, a number of rows in the data source, a number of columns of the data source, and a data type detected (e.g., audio, numeric, categorical, text, date, date duration, image, categorical). The front-end system 126 can cause the collected data to be included within the user interface element 1500.

FIG. 16 is an example of a user interface element 1600 for controlling time in an animation of the graphic representation 104 of the machine learning project 106 is shown. The front-end system 126 can record data received from the back-end system 124 describing changes of the machine learning project 106 at various points in time. The front-end system 126 can store a historical record cataloging the data source metadata 118, the learning sessions 116, the model deployments 120, or the model decisions 122 of the machine learning project. The historical record can catalog a configuration of the elements or indicate the point in time that the component was instantiated. Based on user input to the user interface element 1600, the front-end system 126 can animate the graphic representation 104 to illustrate changes to the machine learning project 106 over time, e.g., illustrating components being added, removed, adjusted, new connections drawn, removed, adjusted, etc. The user interface element 1600 can include a play or pause button, a fast forward button, a rewind button, a skip ahead button, a skip back button, etc.

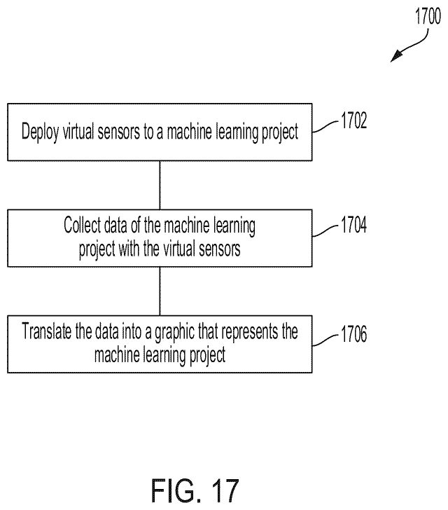

FIG. 17 is an example method 1700 of generating the graphic representation 104 of the machine learning project 106. The data processing system 102 can store instructions on memory devices that cause at least one processor of the data processing system 102 to perform the method 1700. Any computing system or device described herein can execute the method 1700. The method 1700 includes an ACT 1702 of deploying virtual sensors to a machine learning project. The method includes an ACT 1704 of collecting data of the machine learning project with the virtual sensors. The method includes an ACT 1706 of translating the data into a graphic that represents the machine learning project.

At ACT 1702, the method 1700 includes deploying, the data processing system 102, virtual sensors 128 to the machine learning project 106. The back-end system 124 can deploy the virtual sensors 128 throughout the machine learning project 106, e.g., at least one first virtual sensor 128 to monitor the data source metadata 118, at least one second virtual sensor 128 to monitor the learning session 116, at least one third virtual sensor 128 to monitor the model deployment 120, and at least one fourth virtual sensor 128 to monitor the model decision 122. The virtual sensors 128 can be located at various points within the machine learning project 106. For example, the virtual sensors 128 can be stored within code modules, functions, data elements, data storage elements. Each virtual sensor 128 can be stored at a location where the virtual sensor 128 can monitor a component of the machine learning project 106. For example, the first virtual sensor 128 that monitors the data source metadata 118 can be located at a first point in the machine learning project 106 that accesses and detects information regarding the data source metadata 118. The second virtual sensor 128 can be located at a second point in the machine learning project 106 that accesses and detects information regarding the learning session 116. The third virtual sensor 128 can be located at a third location that accesses and detects information regarding the model deployment 120. The fourth virtual sensor 128 can be located at a fourth location that accesses and detects information regarding the model decision 122.

The back-end system 124 can deploy the virtual sensors 128 to the machine learning project 106 by causing the virtual sensors 128 to be stored at various locations in the machine learning project 106. Each of the virtual sensors 128 can monitor a data point, data element, status, or configuration of the machine learning project 106. The virtual sensors 128 can detect the generation of new components of the machine learning project 106, the deletion of existing components of the machine learning project 106, a reconfiguration of components of the machine learning project 106. For example, one of the virtual sensors 128 can identify that new learning session 116 is implemented. Another virtual sensor 128 can identify that the data source metadata 118 was used by a first learning session 116 but has been changed to be provided to a second learning session 116.

At ACT 1704, the method 1700 includes collecting, by the data processing system 102, data of the machine learning project 106 with the virtual sensor 128. The virtual sensors 128 can generate data streams indicating periodic values of data points or data elements, indications of changes of value, indications of new data elements being created or existing data elements being removed. The data streams can be event streams. The data streams can indicate real-time or near real-time data. The back-end system 124 can aggregate or collect the data of the virtual sensors 128 and store the data in one or more databases or data storage elements. The back-end system 124 can provide the data to the front-end system 126.

At ACT 1706, the method 1700 includes translating, by the data processing system 102, the collected data into at least one graphic that represents the project. The front-end system 126 can apply a visual language to the collected data to translate the data into visual representations of the machine learning project 104. The visual language can include a set of rules indicating the shapes, sizes, or locations of the various graphic components that make up the graphic representation 104. The front-end system 126 can apply the rule sets to the data and generate the graphics based on the application of the data to the rule sets. For example, a rule can indicate that when a new learning session 116 is implemented in the machine learning project 106, the front-end system 126 should render a sphere in the graphic representation 104 to represent the new learning session 116. Another rule can indicate that if data source is used by the learning session, a connection should be drawn by the front-end system 126 between an entity representing metadata of the data source and a graphic representing the learning session. The graphic representation 104 of the machine learning project 106 can be rendered by the computing system 108.

FIG. 18 is a block diagram of an example of the data processing system 102. The data processing system 102 can include or be general-purpose computers, network appliances, mobile devices, servers, cloud computing systems, or other electronic systems. The data processing system 102 can include at least one processor 1802, at least one memory 1804, at least one storage device 1806, and at least one input/output device 1808. The processor 1802, the memory 1804, the storage device 1806, and the input/output device 1808 can be interconnected, for example, using at least one system bus 1810. The processor 1802 can process instructions for execution within the data processing system 102. The processor 1802 can include a single-threaded processor. The processor 1802 can include a multi-threaded processor. The processor 1802 can process instructions stored in the memory 1804 or on the storage device 1806.

The memory 1804 can store information within the data processing system 102. The memory 1804 can include a non-transitory computer-readable medium. The memory 1804 can include a volatile memory unit. The memory 1804 can include a non-volatile memory unit. The storage device 1806 can provide mass storage for the data processing system 102. The storage device 1806 can include a non-transitory computer-readable medium. The storage device 1806 can include a hard disk device, an optical disk device, a solid-date drive, a flash drive, or some other large capacity storage device. The storage device 1806 can store long-term data (e.g., database data, file system data, etc.). At least one input/output device 1808 can perform input/output operations for the data processing system 102. The input/output device 1808 can include one or more of a network interface devices, e.g., an Ethernet card, a serial communication device, e.g., an RS-232 port, and/or a wireless interface device, e.g., a Wi-Fi card (e.g., an 802.11 card), a 3G wireless modem, a 4G wireless modem, or a 5G wireless modem. In some implementations, the input/output device 1808 can include driver devices configured to receive input data and send output data to other input/output devices, e.g., keyboard, printer and display devices 1812. The input/output devices 1812 can include smartphones, laptops, tablets, desktop computers, printers, speakers, microphones, or other devices.

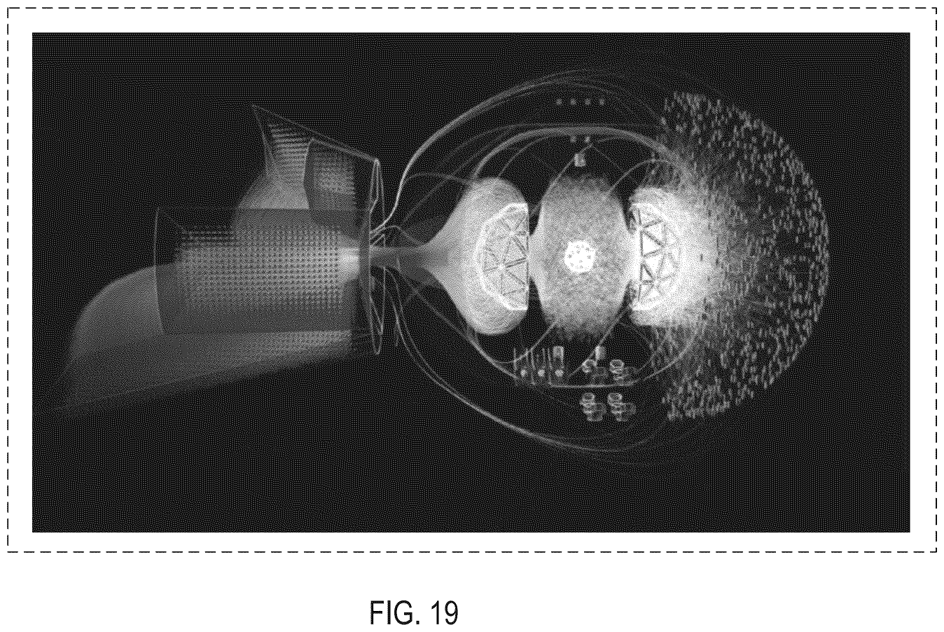

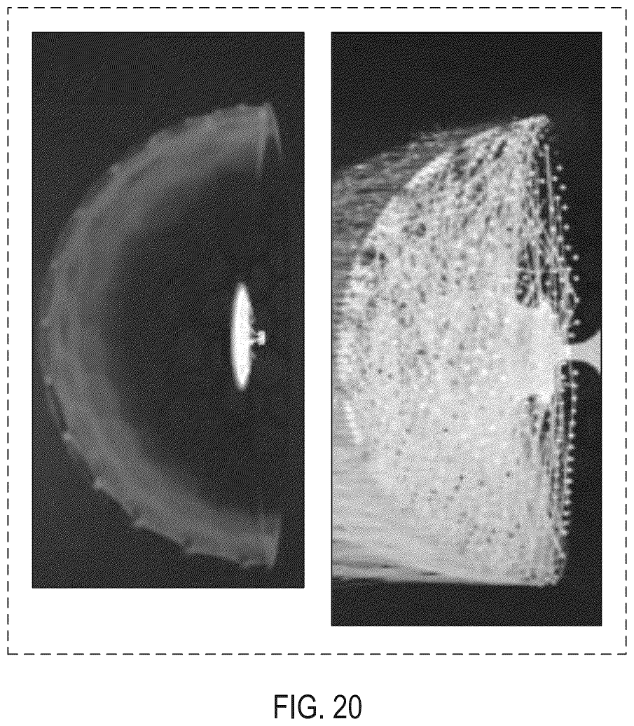

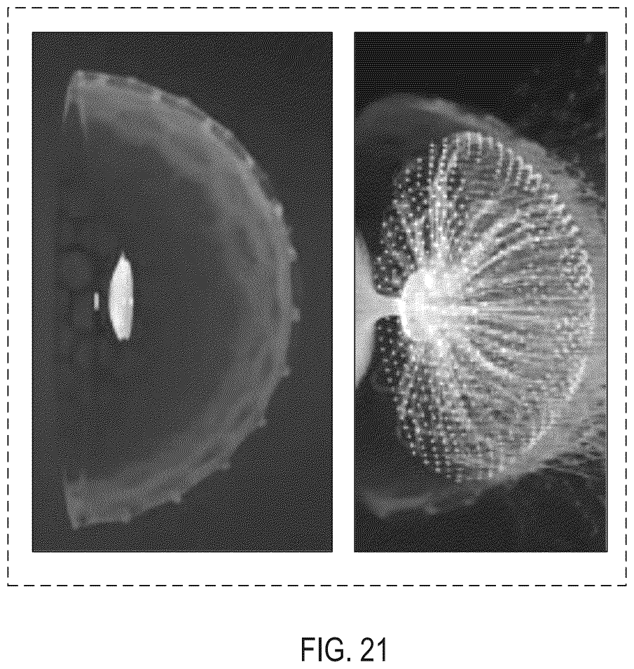

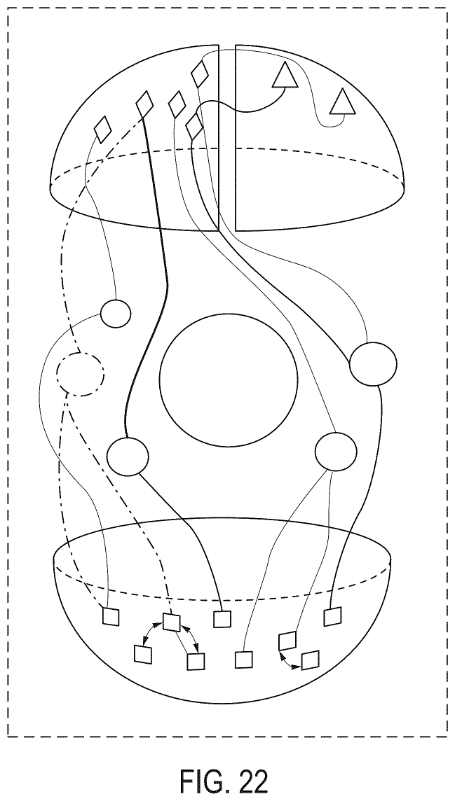

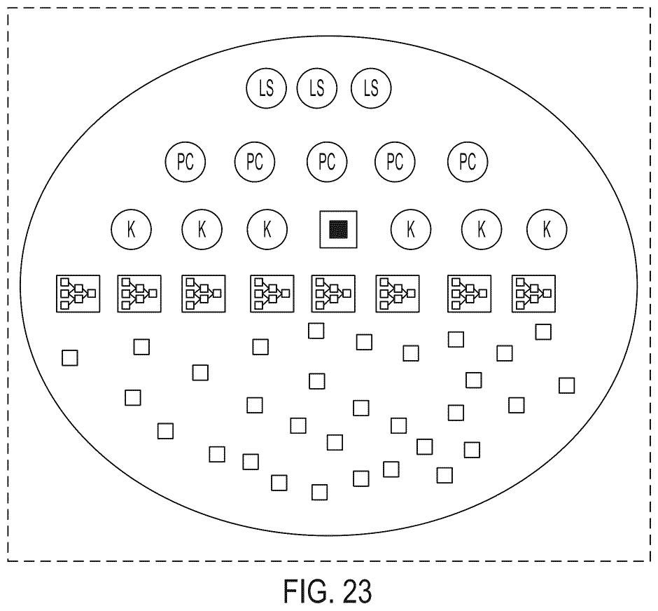

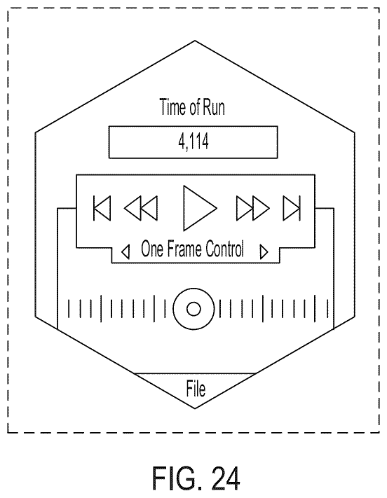

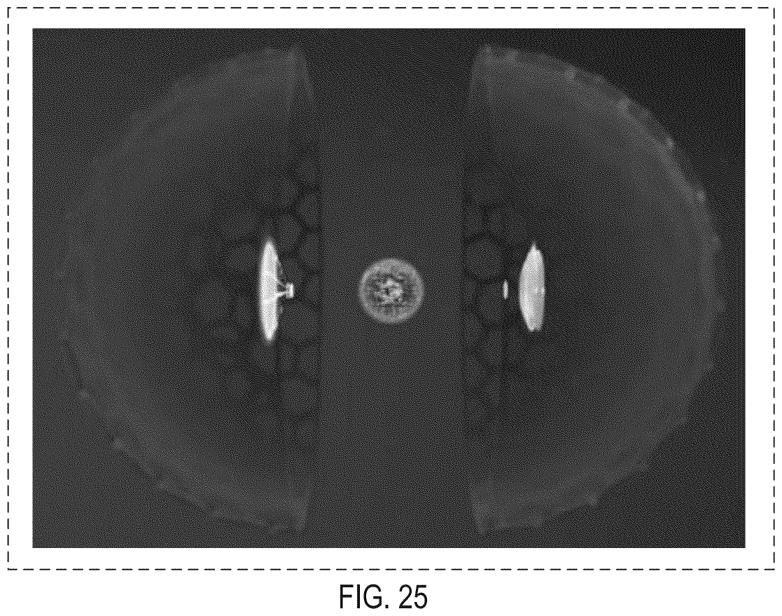

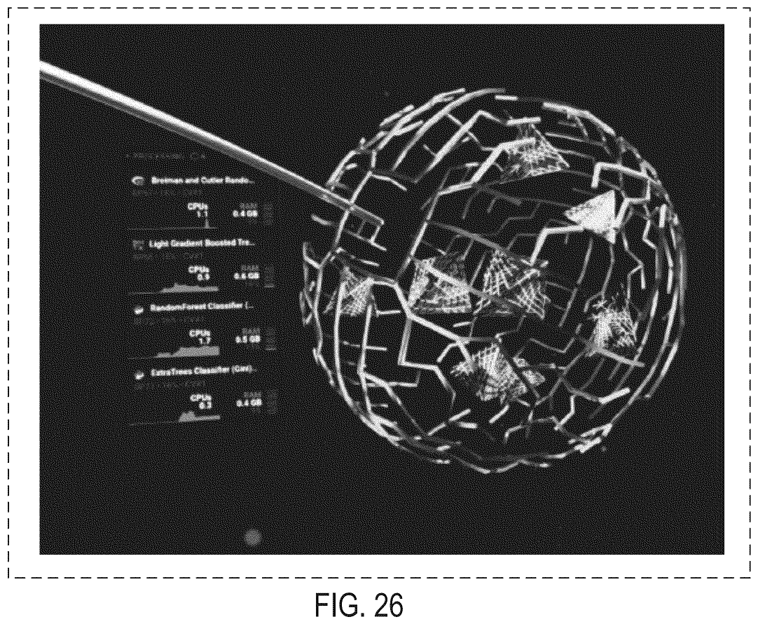

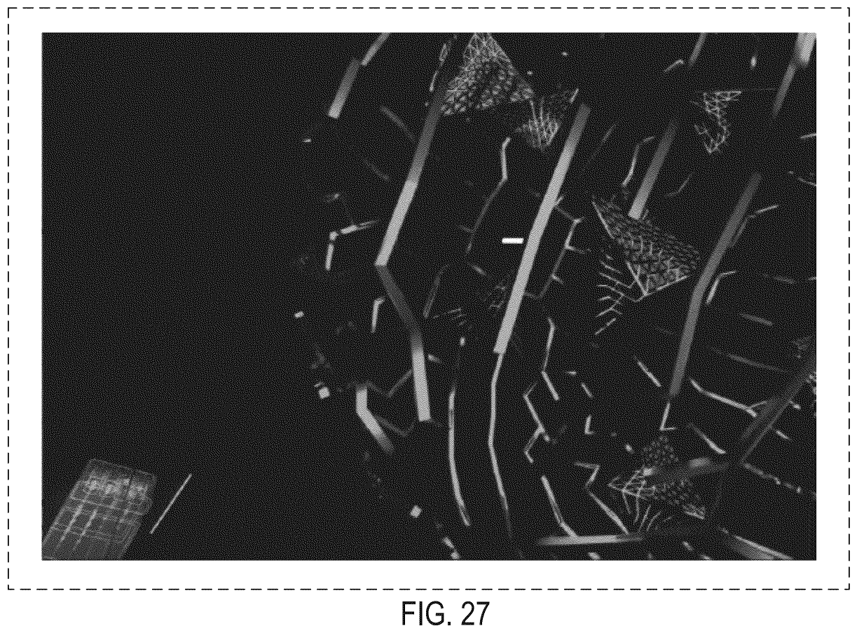

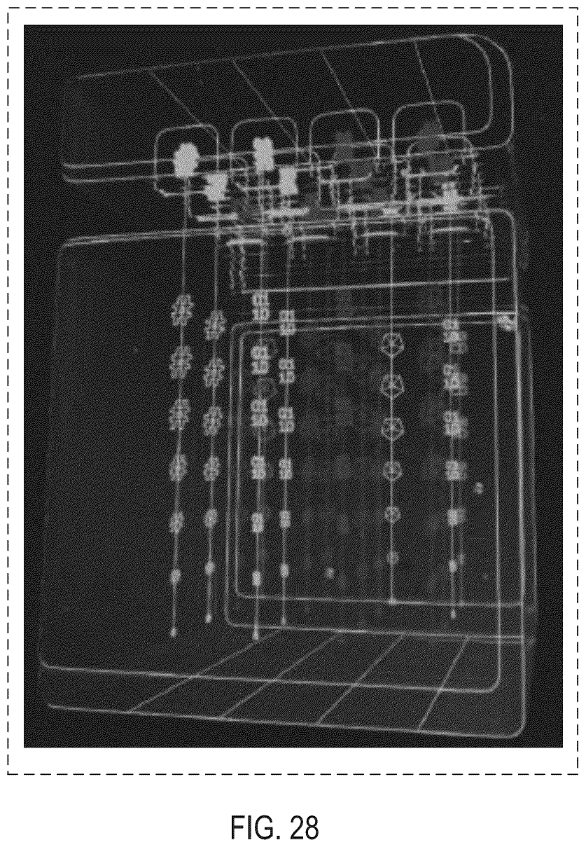

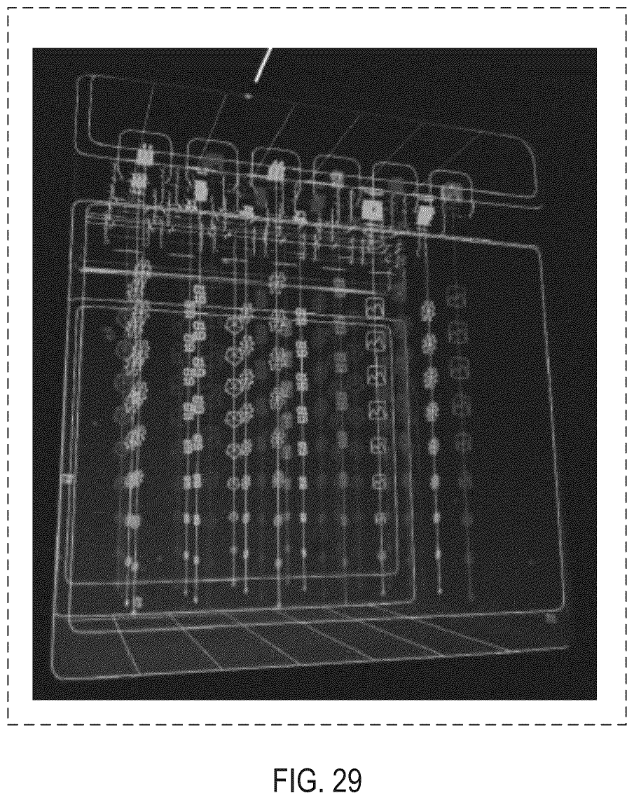

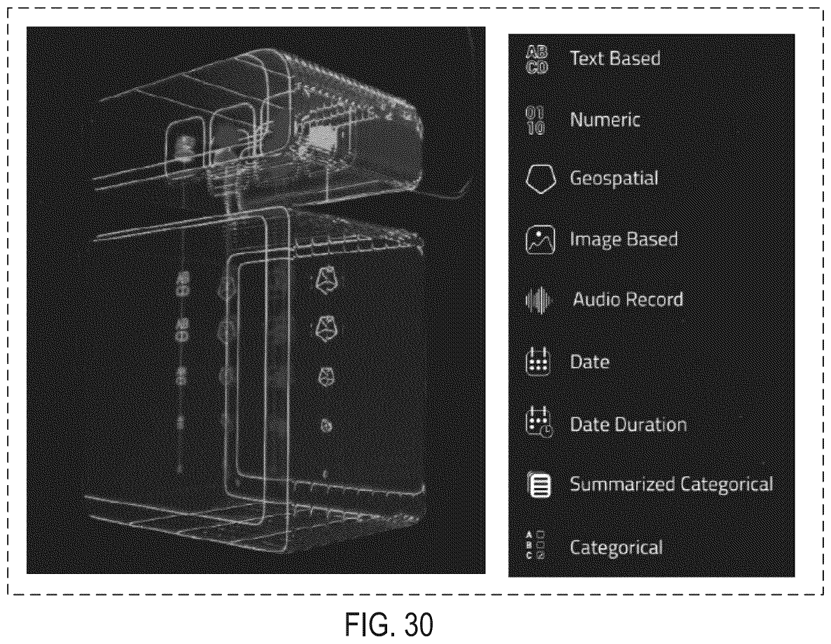

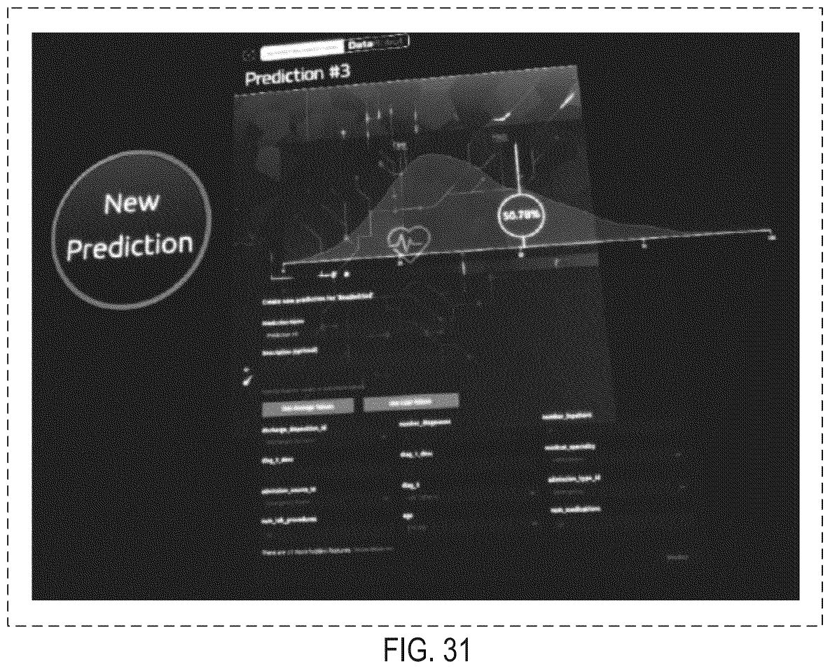

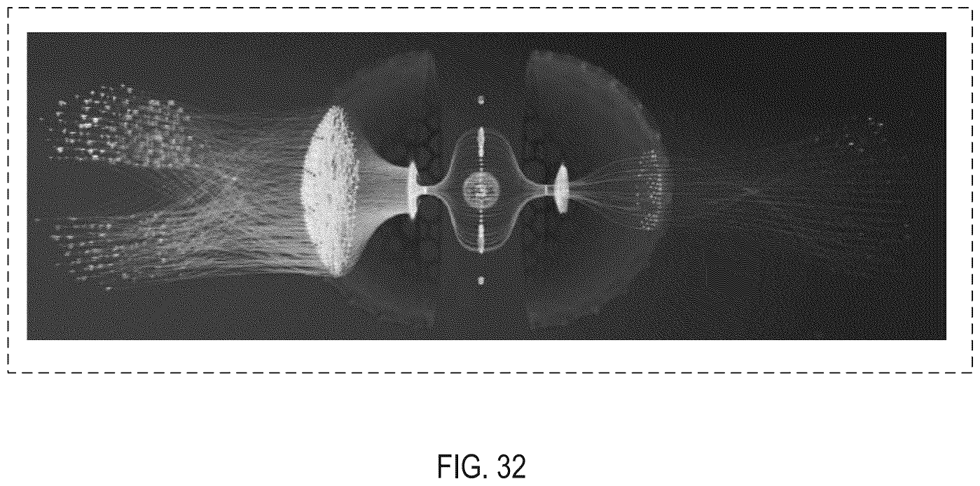

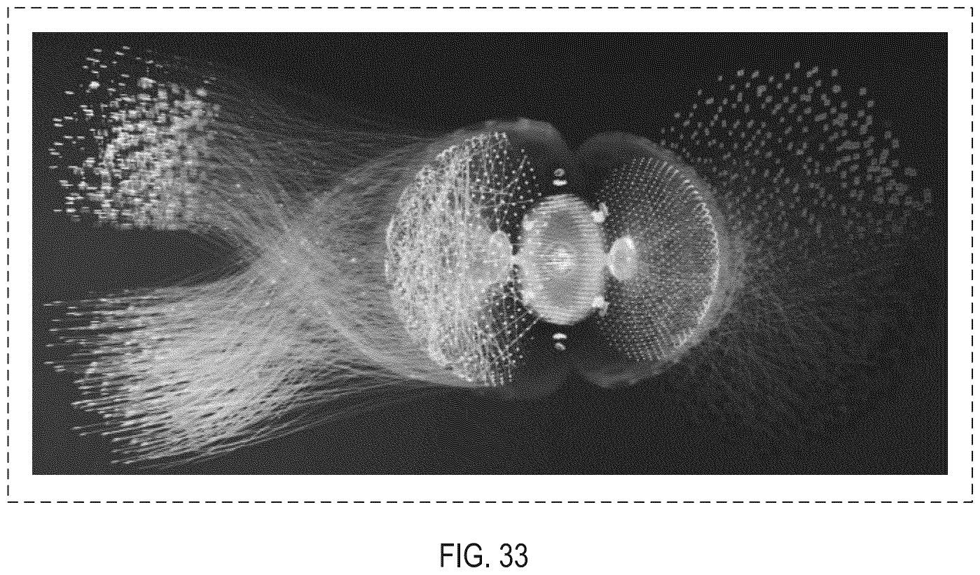

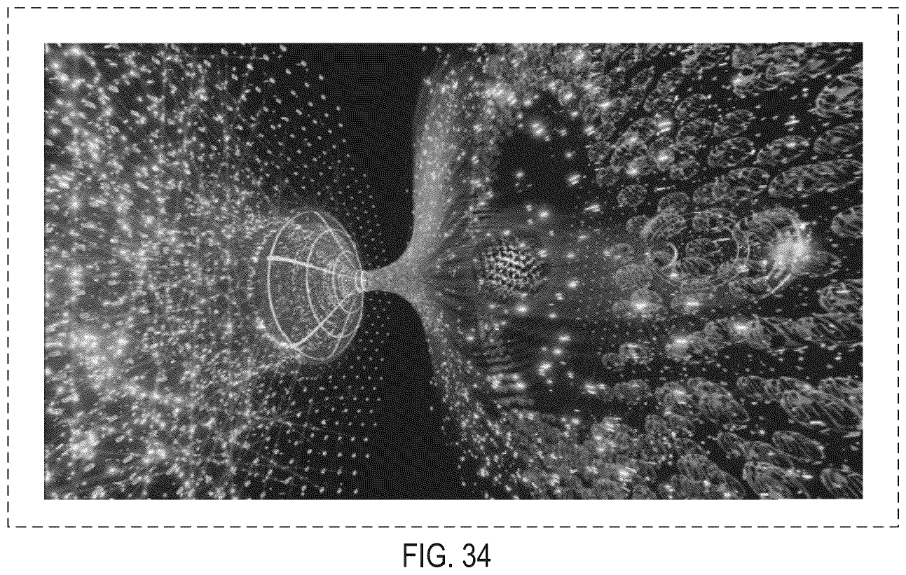

FIGS. 19-34 depict display screens or portions thereof with example graphical user interfaces. The outermost broken lines in FIGS. 19-34 illustrate the display screen or portion thereof. The graphical user interfaces may be generated, provided, and/or otherwise included with one or more embodiments described herein. Various modifications to the depicted graphical user interfaces are contemplated, such as certain of the depicted elements of one graphical user interface may be added to another graphical user interface, one or more depicted elements of certain graphical user interfaces may be removed, and/or other modifications (e.g., various graphical user interfaces may be linked together as a sequence of images to form an animated graphical user interface sequence). Further, the depicted graphical user interfaces may include various colors, color combinations, and/or other visual elements (e.g., textures, patterns, etc.) to illustrate contrasts in appearance. Moreover, modifications of the values of any depicted numbers, words, and letters is contemplated with such changes intended to fall within the scope of the disclosure. Thus, the depicted graphical user interfaces may have a variety of different appearances.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods can be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system, comprising:
a data processing system comprising one or more processors, coupled with memory, to:
deploy, for a machine learning project, a plurality of virtual sensors at a first location of a plurality of locations to detect metadata of a data source of the machine learning project, at a second location of the plurality of locations to detect deployment information of a model trained for the machine learning project, and at a third location of the plurality of locations to detect learning session information for creation of the model;
collect, via the plurality of virtual sensors deployed at the plurality of locations, data for the machine learning project; and
translate, for render on a computing system, the data collected via the plurality of virtual sensors into a plurality of graphics including a graphic representing the metadata of the data source, a graphic representing the deployment of the model, and a graphic representing the learning session.

2. The system of claim 1, wherein a virtual sensor of the plurality of virtual sensors:
monitors values of a data element of the machine learning project; and
streams the values of the data element to the data processing system.

3. The system of claim 1, wherein a virtual sensor of the plurality of virtual sensors includes a web-hook that monitors a data element of the machine learning project.

4. The system of claim 1, comprising the data processing system to:
apply a visualization rule to the data collected based on a virtual sensor of the plurality of virtual sensors;
identify a visual appearance of one or more of the plurality of graphics based on the visualization rule and the data; and
generate the one or more of the plurality of graphics to include the visual appearance.

5. The system of claim 1, comprising the data processing system to:
receive, from the computing system, a selection of the graphic representing the learning session; and
provide, for render on the computing system, a plurality of entities within the graphic representing the learning session, the plurality of entities representing components of the learning session.

6. The system of claim 1, comprising the data processing system to:
determine, based on the data, a health level of a component of the machine learning project;
compare the health level to a threshold; and
update a visual appearance of at least one of the plurality of graphics or connections between the plurality of graphics responsive to the health level satisfying the threshold.

7. The system of claim 1, comprising the data processing system to:
determine, based on the data, a health level of a connection of connections between the plurality of graphics;
compare the health level to a threshold;
generate an update to the machine learning project; and
modify a visual appearance of the connection.

8. The system of claim 1, wherein the learning session designs and trains the model of the machine learning project based on a machine learning problem received from the computing system.

9. The system of claim 1, comprising the data processing system to:
generate data causing the computing system to display a time control element;
receive a selection of the time control element from the computing system; and
animate at least one of the plurality of graphics or connections between the plurality of graphics based on a historical record of a plurality of states of the machine learning project at a plurality of points in time.

10. The system of claim 9, comprising the data processing system to:
animate at least one of the plurality of graphics or the connections by adding, removing, or adjusting entities of the plurality of graphics based on the historical record.

11. The system of claim 1, wherein the graphic representing the metadata of the data source includes a first spherical portion including a metadata entity representing metadata of the data source of the machine learning project; and
wherein the graphic representing the deployment of the model is a second spherical portion including a deployment entity representing the deployment of the model trained for the machine learning project.

12. The system of claim 11, comprising the data processing system to:
draw, based on the data, a first connection between the metadata entity and the graphic representing the learning session and a second connection between the graphic representing the learning session and the deployment entity; and
wherein the first connection and the second connection indicate that the learning session uses data of the data source to produce the deployment of the model.

13. The system of claim 11, comprising the data processing system to:
generate, based on the data, a third spherical portion, the third spherical portion including a decision entity indicating a decision produced by the deployment of the model of the machine learning project; and
draw, based on the data, a connection between the deployment entity and the decision entity;
wherein the connection indicates that the deployment of the model of the machine learning project produces the decision.

14. The system of claim 11, comprising the data processing system to:
generate the first spherical portion to be a semi-sphere;
generate, based on the data, a third spherical portion, the third spherical portion including a decision entity indicating a decision produced by the deployment of the model of the machine learning project; and
generate the second spherical portion and the third spherical portion to be quarter-spheres.

15. A method, comprising:
deploying, by a data processing system comprising one or more processors, coupled with memory, for a machine learning project, a plurality of virtual sensors at a first location of a plurality of locations to detect metadata of a data source of the machine learning project, at a second location of the plurality of locations to detect deployment information of a model trained for the machine learning project, and at a third location of the plurality of locations to detect learning session information for creation of the model;
collecting, by the data processing system, via the plurality of virtual sensors deployed at the plurality of locations, data for the machine learning project; and
translating, by the data processing system, for render on a computing system, the data collected via the plurality of virtual sensors into a plurality of graphics including a graphic representing the metadata of the data source, a graphic representing the deployment of the model, and a graphic representing the learning session.

16. The method of claim 15, wherein a virtual sensor of the plurality of virtual sensors:
monitors values of a data element of the machine learning project; and
streams the values of the data element to the data processing system.

17. The method of claim 15, wherein a virtual sensor of the plurality of virtual sensors includes a web-hook that monitors a data element of the machine learning project.

18. The method of claim 15, further comprising:
applying, by the data processing system, a visualization rule to the data collected based on a virtual sensor of the plurality of virtual sensors;
identifying, by the data processing system, a visual appearance of one or more of the plurality of graphics based on the visualization rule and the data; and
generating, by the data processing system, the one or more of the plurality of graphics to include the visual appearance.

19. A computer readable medium that stores instructions thereon, that, when executed by one or more processors, cause the one or more processors to:
deploy, for a machine learning project, a plurality of virtual sensors at a first location of a plurality of locations to detect metadata of a data source of the machine learning project, at a second location of the plurality of locations to detect deployment information of a model trained for the machine learning project, and at a third location of the plurality of locations to detect learning session information for creation of the model;
collect, via the plurality of virtual sensors deployed at the plurality of locations, data for the machine learning project; and
translate, for render on a computing system, the data collected via the plurality of virtual sensors into a plurality of graphics including a graphic representing the metadata of the data source, a graphic representing the deployment of the model, and a graphic representing the learning session.

20. The computer readable medium of claim 19, wherein a virtual sensor of the plurality of virtual sensors:
monitors values of a data element of the machine learning project; and
streams the values of the data element to the one or more processors.
